(19) United States
(12) Patent Application Publication
(10) Pub. No.: US 2003/0205402 A1
(43) Pub. Date: Nov. 6, 2003

(54) Data transmission cable

(75) Inventors: Osamu Koyasu, Chiba (JP); Kazunaga Kobayashi, Chiba (JP); Keiji Ohashi, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJIKURA LTD., Tokyo (JP)

(21) Appl. No.: 10/423,949

(22) Filed: Apr. 28, 2003

(30) Foreign Application Priority Data
May 1, 2002 (JP) 2002-129911
May 17, 2002 (JP) 2002-143689
May 17, 2002 (JP) 2002-143693
May 20, 2002 (JP) 2002-144904
May 27, 2002 (JP) 2002-152271
May 28, 2002 (JP) 2002-154563

(51) Int. Cl. H02G 3/00

(52) U.S. Cl. 174/113 C

(57) ABSTRACT

Four twisted pairs 115 are forced to be brought into contact with a hollow filler 113 and collectively arranged around the hollow filler 113 so as to deform a contact portion into a concave form. The outer periphery of the four twisted pairs 115 collectively arranged is covered with a jacket 117 to form a data transmission cable 111.

### BACKGROUND OF THE INVENTION

1. Field of the Invention

The present invention relates to a data transmission cable for use in data transmission such as a LAN construction, and specifically, relates to a LAN cable capable of improving electric properties.

2. Description of the Related Art

As a data transmission cable such as a LAN cable, one composed of the following structure has been hitherto known as shown in FIG. 1. Four twisted pairs 805 are collectively arranged, and an outer periphery thereof is covered with a jacket 807. Each of the twisted pairs 805 is formed by twisting two insulated wires 803 together.

As another data transmission cable, one composed of the following structure has been known as shown in FIG. 2. Four insulated wires 833 are collectively arranged around a round filler 831, and a metallic tape is longitudinally attached to or wrapped around an outer periphery thereof. Furthermore, the outer periphery thereof is covered with a jacket 835.

As shown in FIGS. 3 and 4, LAN cables of the CAT6 standard composed of the following structure have been known. Four twisted pairs 823 are collectively arranged around a round filler 821 or a cross-shaped filler 827, and an outer periphery thereof is covered with a jacket 825.

### SUMMARY OF THE INVENTION

First Problem

However, in the LAN cable as shown in FIG. 1, spaces 809 are created between the four twisted pairs 805 as a result. Furthermore, when the twisted pairs 805 are obtained by twisting, trajectories 811 are generated, so that the twisted pairs 805 can easily move in a direction parallel to a cross section. When stress is applied, it is difficult to secure a same stable arrangement in any section in the longitudinal direction. Therefore, there has been a problem that distances between the twisted pairs 805 vary and deterioration of a crosstalk characteristic is caused.

In a design phase of the LAN cable, a lay ratio is determined in accordance with a setting of a pitch of the twisted pairs 805, and a length of insulated wires 803 can be calculated for a certain length of the cable. From the length of the insulated wires 803, resistance or an amount of attenuation of center conductors 801 can be calculated. In such a case, when the arrangement of the twisted pairs 805 is disturbed in any cross section in the longitudinal direction, the length of the insulated wires 803 is different from a design value, thus causing deviation from the standard.

Furthermore, in the LAN cable using the round filler 821 as shown in FIG. 3, the round filler has a cross-sectional shape having a constant distance between the center and the outer edge thereof, and the cross-sectional shape is constant in the longitudinal direction. Accordingly, when stress is applied to the cable, the twisted pairs 823 can move in the cross section perpendicular to the longitudinal direction. Therefore, it has been difficult to stably secure a constant arrangement.

The present invention was made in the light of the above problem. According to the present invention, a LAN cable is provided which can prevent a disordered arrangement of the twisted pairs in any cross section perpendicular to the longitudinal direction and which prevents deterioration of the crosstalk characteristic.

According to a first aspect of the present invention, the LAN cable includes insulated wires, each formed by covering a center conductor with an insulator, a plurality of twisted pairs in which each formed by twisting two of the insulated wires, a hollow filler composed of a tubular elastic body and collectively arranged in contact with the plurality of twisted pairs, and a jacket covering an outer periphery of the plurality of twisted pairs collectively arranged.

Second Problem In the case of the data transmission cable using the round filler 831 shown in FIG. 2, since the four insulated wires 833 are arranged around the round filler 831, the data transmission cable has an effect to secure distances between the insulated wires 833 facing each other.

However, there is the following problem in the manufacturing process of arranging the insulated wires 833 around the outer periphery of the round filler 831. When feeding tension for the insulated wires 833 becomes unbalanced or the arrangement is disordered by stress due to bending, differences in wire length are caused among the four insulated wires 833. Accordingly, there has been a problem that transmission delay time difference (referred to as a skew hereinafter) is increased.

Since contact areas of the round filler 831 and each of the insulated wires 833 is small, there has been a problem that the insulated wires 833 easily move in a direction parallel to the cross section and skew characteristics are deteriorated.

Furthermore, along with the spread of a rapid data transmission network such as a storage area network (SAN), as a transmission channel for transmitting a differential signal, a data cable which can minimize the skew of the signal is required to be widely used.

The present invention is made in the light of the above problem. According to the present invention, a data cable capable of improving the skew characteristics can be provided.

According to a second aspect of the present invention, the data transmission cable includes insulated wires wherein each formed by covering a center conductor with an insulator, a rhombus filler provided with a concave portion having a curvature substantially equal to a curvature of an outer periphery of the insulated wires, a metallic tape shielding an outer periphery of the insulated wires after the insulated wires are arranged along the concave portion and twisted, and a jacket covering the metallic tape.

Third Problem

Referring to FIGS. 2 and 3, for the LAN cable, the twist pitch of the insulted wires 833 (or 822) is set in the design phase of the cable, and the lay ratio is determined in accordance with the twist pitch. From the lay ratio, a core length in the insulated wires 833 per unit length is calculated, and an amount of resistance conductor or the amount of attenuation of each insulated wires 833 is calculated. However, there has been a problem that twisting the insulated wires 833, when the bending is applied thereto, for example, at a pass line and the feeding tension for the insulated wires 833 is changed, the core length becomes different from the calculated value, thus sometimes causing deviation from the standard.

A difference in the twist pitch between the two insulated wires 823 is made large enough to improve the crosstalk characteristic. However, the insulated wires with a short twist pitch and a long twist pitch are different in a manufacturing line speed for twisting. Since the manufacturing time for twisting the insulated wires with the short twist pitch is naturally longer than that of the insulated wires with a long twist pitch, there has been a problem that a manufacturing efficiency is lowered.

Furthermore, the LAN cables currently used in the general LAN construction mainly includes 10 BASE cables or 100 BASE cables. Along with an increase in transmission capacity or an increase in transmission speed, the LAN is transited to 100 BASE transmission or gigabit transmission. Accordingly, LAN cables with excellent electric properties are desired.

The present invention was made in the light of the above problem. According to the present invention, a LAN cable capable of preventing deterioration of the crosstalk characteristics can be provided.

According to a third aspect of the present invention, the LAN cable includes insulated wires wherein each formed by covering a center conductor with an insulator, twisted pairs wherein each formed by twisting two of the insulated wires, a grooved filler having a round section provided with a plurality of concave grooves in which each being in contact with part of a trajectory of each of the twisted pairs drawn in a twisting direction of the twisted pairs, and a jacket including an insulator covering an outer periphery of a combination integrated by collectively arranging the grooved filler and the twisted pairs.

Fourth Problem

Since the twisted pairs 823 can easily move in the direction parallel to the cross section, there has been a problem that, when stress is applied, the crosstalk characteristics are deteriorated in accordance with change of the distance between the twisted pairs 823 adjacent to each other.

In the case of the conventional cable shown in FIG. 4, partition walls 829 of the cross-shaped filler 823 are widened outward, the partition walls 829 separating the twisted pairs 823. Accordingly, the twisted pairs 823 easily move. Therefore, when bending or side stress is applied to the LAN cable, the twisted pairs 823 move and the distances between the twisted pairs 823 adjacent to each other are reduced, thus deteriorating the crosstalk characteristic.

The present invention was made in the light of the above problem. The present invention can provide a LAN cable capable of preventing the deterioration of the crosstalk characteristics. Even when the cable is pressed down, the lay of the twisted pairs is not disturbed, and the deterioration of the electric properties caused by the disturbed lay of the twisted pairs can be prevented.

According to a fourth aspect of the present invention, the data transmission cable includes insulated wires wherein each formed by covering a center conductor with an insulator, a plurality of twisted pairs wherein each formed by twisting two of the insulated wires, a buffer layer lying for buffering in a portion where the plurality of twisted pairs are close to each other and enveloping each of the twisted pairs, and a jacket covering an outer periphery of the buffer layer.

According to a fifth aspect of the present invention, the data transmission cable includes insulated wires wherein each formed by covering a center conductor with an insulator, a plurality of twisted pairs wherein each formed by twisting two of the insulated wires, an anchor filler accommodating and arranging the twisted wires in spaces of shape substantially equal to an outline of the twisted wires, and a jacket covering the anchor filler.

Fifth Problem

In the case of the LAN cable using the round filler 821 shown in FIG. 3, the round filler 821 has an effect to secure the distances between the twisted pairs 823 facing each other around the round filler 821 with a round section.

However, since the twisted pairs 823 adjacent to each other can easily move in the direction parallel to the cross section, when stress is applied, the crosstalk characteristic is deteriorated in accordance with change in the distance between the twisted pairs 823 adjacent to each other.

In the design phase of the LAN cable, the setting of the pitch and the lay ratio of the twisted pairs 823 are determined. Accordingly, the core length in the cable of a certain length can be calculated, and the conductor resistance, the amount of attenuation, and the skew can be calculated from the core length. However, if the arrangement of the twisted pairs is disordered, the core length differs from the designed value. Consequently, the amount of attenuation or the skew becomes uncalculated values, thus causing deviation from the standard.

The current LAN is operated mainly based on 10 Base or 100 Base, and especially hereafter, the LAN will be transited to 100 Base transmission. Furthermore, it is necessary to lay an optical LAN cable in place of the metallic LAN cable to transmit a large amount of information at higher speed in the future. In this case, there will be a problem that the optical LAN cable needs to be newly laid.

The present invention is made in the light of the above description. The present invention provides an optical fiber composite LAN cable capable of preventing the deterioration of the crosstalk characteristic and reducing work of laying the optical fiber cable in response to the increase in transmission amount of communication in the future.

According to a sixth aspect of the present invention, the optical fiber composite LAN cable includes a twisted pair formed by twisting insulated wires wherein each formed by covering a center conductor with an insulator, an optical fiber cable; a cross-shaped filler including the optical fiber cable in a center portion and partition walls arranged to be orthogonal to each other in four directions from the center portion to accommodate and arrange the twisted pairs in separate spaces provided between the partition walls, and a jacket covering an outer periphery of the cross-shaped filler.

### BRIEF DESCRIPTION OF THE DRAWINGS

FIG. 1 shows a conventional LAN cable.

FIG. 2 is a cross-sectional view showing a conventional LAN cable including a round shaped filler 831 and insulated wires 833.

FIG. 3 shows a conventional LAN cable using a round filler 821.

FIG. 4 shows a conventional LAN cable using a cross-shaped filler 827.

FIG. 5 is a cross-sectional view showing a constitution of a data transmission cable 111 according to a first embodiment of the present invention.

FIG. 6 is a cross-sectional view showing a constitution of an application of the data transmission cable of the present invention.

FIG. 7 is a table showing a cable specification of the data transmission cable of the present invention.

FIG. 8 is a cross-sectional view showing a constitution of a hollow filler used in the data transmission cable of the present invention.

FIG. 9 is a table showing values of a composite dielectric constant corresponding to an outer diameter and a thickness of the hollow filler.

FIG. 10 is a cross-sectional view showing a constitution of a data cable 211 according to a second embodiment of the present invention.

FIG. 11 is a side view showing the data cable 211 according to the second embodiment of the present invention.

FIG. 12 is a cross-sectional view of a rhombus filler 213.

FIG. 13 is a view showing a correlation between the rhombus filler 213 and insulated wires 215.

FIG. 14 is a table showing a cable specification of the data cable 211 according to the embodiment of the present invention.

FIG. 15 is a cross-sectional view showing a constitution of a data transmission cable 301 according to a third embodiment of the-present invention.

FIG. 16A is a cross-sectional view of a grooved filler 311a including horseshoe-shaped grooves 323a, and FIG. 16B is a cross-sectional view of a grooved filler 311b including V-shaped grooves 323b.

FIG. 17 is a table showing a cable specification of the data transmission cable 301 according to the present invention.

FIG. 18 is a cross-sectional view showing a constitution of a data transmission cable 303 according to the present invention.

FIG. 19 is a cross-sectional view of a star filler 311c according to a modification of the third embodiment of the present invention.

FIG. 20 is a table showing a cable specification of the data transmission cable 303 according to the third embodiment of the present invention.

FIG. 21 is a cross-sectional view showing a constitution of a data transmission cable 411 according to a fourth embodiment of the present invention.

FIG. 22 is a table showing a cable specification of the data transmission cable 411 according to the present invention.

FIG. 23 is a cross-sectional view showing a constitution of a data transmission cable 431 according to the present invention.

FIG. 24 is a table showing a cable specification of the data transmission cable 431 according to a modification of the fourth embodiment of the present invention.

FIG. 25 is a cross-sectional view showing a constitution of a data transmission cable 511 according to a fifth embodiment of the present invention.

FIG. 26 is a cross-sectional view showing a constitution of an anchor filler 513.

FIG. 27 is a table showing a cable specification of the data transmission cable 511 according to the present invention.

FIG. 28 is a cross-sectional view showing a constitution of a data transmission cable 551 according to the present invention.

FIG. 29 is a cross-sectional view showing a constitution of an anchor filler 553.

FIG. 30 is a table showing a cable specification of the data transmission cable 551 according to a modification of the fifth embodiment of the present invention.

FIG. 31 is a cross-sectional view showing a constitution of an optical fiber composite data transmission cable 601 according to a sixth embodiment of the present invention.

FIG. 32 is a cross-sectional view showing a constitution of a fin filler 613.

FIG. 33 is a table showing a cable specification of the optical fiber composite data transmission cable 601 according to the present invention.

FIG. 34 is a cross-sectional view showing a constitution of an optical fiber composite data transmission cable 603 according to the present invention.

FIG. 35 is a cross-sectional view showing a constitution of a cross-shaped filler 633.

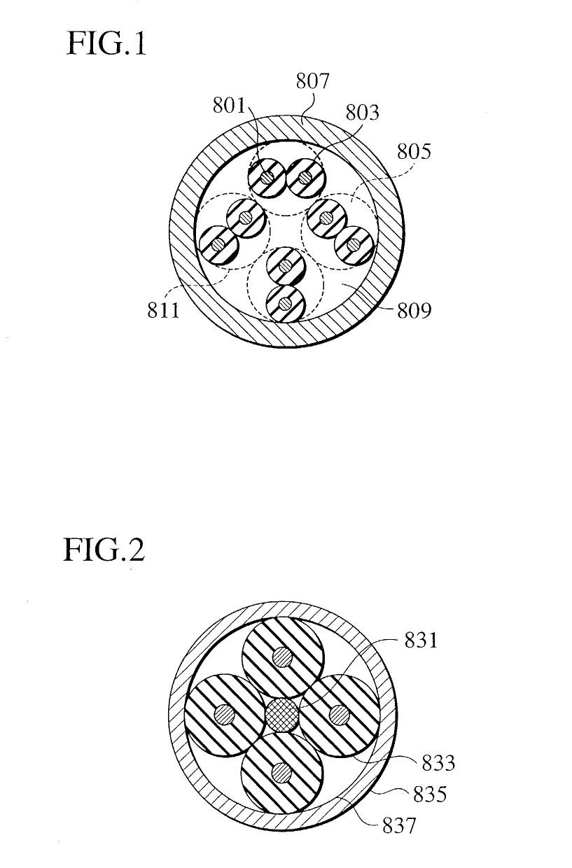

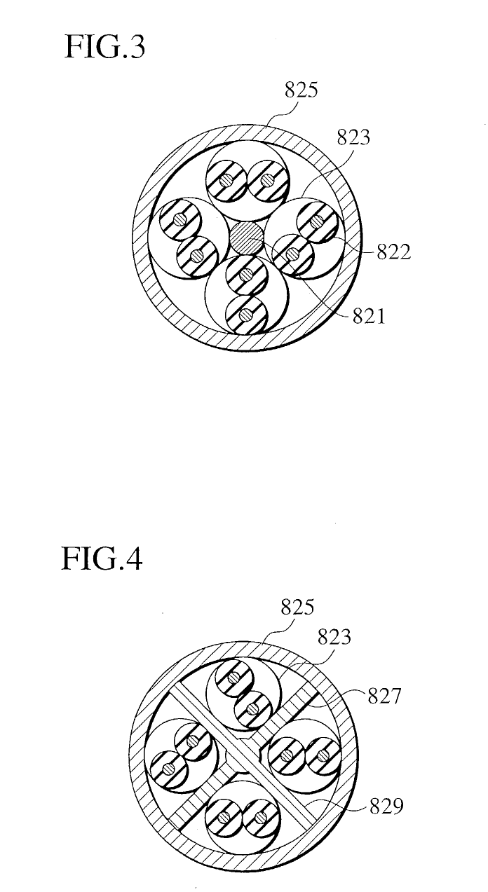

### DESCRIPTION OF THE PREFERRED EMBODIMENT

First Embodiment

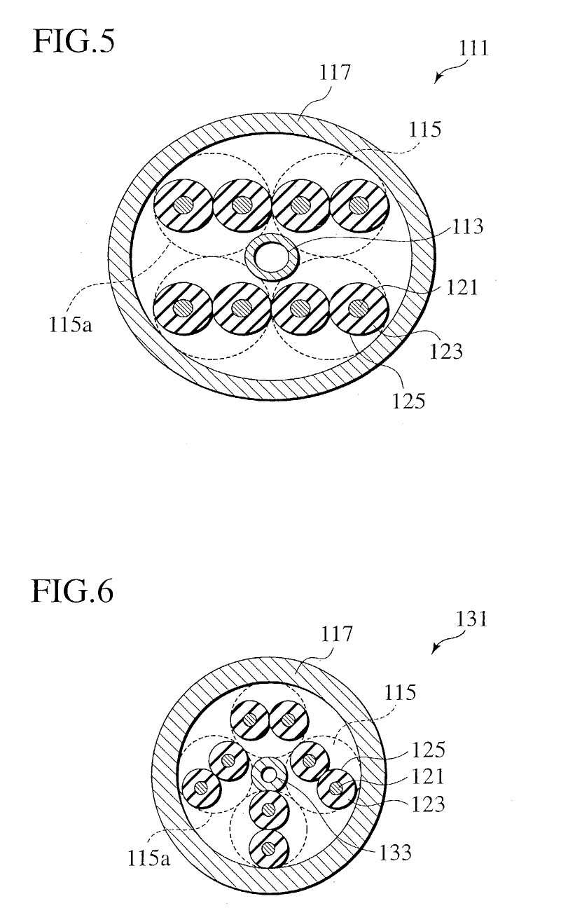

FIG. 5 is a cross-sectional view showing a constitution of a LAN cable 111 according to an embodiment of the present invention. In the LAN cable 111 as the data transmission cable, four twisted pairs 115 are collectively arranged so as to force the elastic hollow filler 113 to a center direction in such a manner that directions formed by center conductor 125 of the respective twisted pairs 115 are parallel to each other. The four twisted pairs 115 are covered with a jacket 117 on an outer periphery thereof.

When the four twisted pairs 115 are collectively arranged, a space with a diameter of about 1 mm is appeared in a center portion. In the embodiment, the hollow filler 113 is arranged in the space. Since the hollow filler 113 is composed of an elastic body of tubular shape and the inside thereof is hollow, the hollow filler 113 has an adequate flexibility. When the twisted pairs 115 are forced to the hollow filler 113, each portion of the hollow filler 113 contacting each twisted pair 115 is deformed into a concave shape in accordance with the shape of the twisted pair 115. Therefore, the contact areas of the twisted pairs 115 and the hollow filler 113 are increased. Distances between the center and the outer edge of the hollow filler 113 becomes unequal because of the deformation of the hollow filler 113. Consequently, the twisted pairs 115 are effectively prevented from moving in a plane intersecting the longitudinal direction.

Each of the twisted pairs 115 is formed by twisting the two insulated wires 125 individually formed by covering conductors 121 with insulators 123 such as resin. Lines 15a indicate trajectories of the outer edges of the twisted pairs 115 when the twisted pairs 115 are twisted.

Preferably, a material of the jacket 117 as the outer periphery of the cable is polyvinyl chloride (PVC), a recyclable eco material composed of a polyolefin material, or a non-halogen flame-retardant material.

The above described eco material is composed of a non-halogen flame-retardant resin composition. Especially, the eco material is composed by adding 20 parts by weight or more and less than 50 parts by weight of metal hydroxide and 2 parts by weight or more and less than 10 parts by weight of an auxiliary frame retardant to 100 parts by weight of a polyolefin resin. A specific gravity thereof is not more than 1.14, and an oxygen index is 24 or more but not more than 34. The eco material passes a 60 degree inclined combustion test specified in JIS C3005 when used as a cover material. Moreover, the eco material may be a non-halogen flame-retardant resin material, and especially, composed by adding 20 parts by weight or more and less than 50 parts by weight of metal hydroxide, 0.5 parts by weight or more and less than 2.5 parts by weight of red phosphorus, and 1 parts by weight or more and less than 6 parts by weight of carbon black to 100 parts by weight of polyolefin resin. The specific gravity is not more than 1.14, and the oxygen index is 24 or more and not more than 34. This eco material passes the 60 degree inclined combustion test specified in JIS c3005 when used as a cover material. The same applies to other embodiments to be described later.

Each of the conductors 121 may be either a single wire or a twisted wire. Use of a silver-plated annealed copper wire or a tin-plated copper wire is effective to improve the attenuation amount in high frequency. Each of the insulators 123 is composed of a foam layer of polyethylene foam (PE) or a skin foam structure of polyethylene, which is effective to improve electric properties and flexibility.

A description will be made of an operational effect of the LAN cable 111 with reference to FIG. 5. First, as shown in FIG. 5, the four twisted pairs 115 are prepared, each of which is formed by combining in parallel the two insulated wires 125 individually formed by covering the conductor 121 with the insulator 123. Simultaneously, the hollow filler 113 composed of the elastic body of tubular shape is prepared.

Subsequently, the four twisted wires 115 are collectively arranged around the hollow filler 113 in such a manner that the four twisted wires 115 are pressed to be brought into contact with the hollow filler 113 and each contact portion is deformed into concave portion. Furthermore, the outer periphery of the collectively arranged four twisted pairs 115 is covered with the jacket 117 to form the LAN cable 111.

As a result, the four twisted pairs 115 and the hollow filler 113 are collectively arranged around the hollow filler 113 such that the twisted pairs 115 and the hollow filler 113 are in contact with each other or side pressure is applied thereto, and the respective twisted pairs 115 are held between the hollow filler 113 and the jacket 117. Accordingly, the twisted pairs 115 can be prevented from moving in the direction parallel to the cross section, and the disordered arrangement of the twisted pairs 115 can be prevented in any cross section in the longitudinal direction. Therefore, each of the distances between the twisted pairs 115 adjacent to each other does not change, thus preventing the deterioration of the crosstalk characteristic of the LAN cable 111.

FIG. 6 is a cross-sectional view showing a constitution of a modification of the data transmission cable. In the LAN cable 131, the four twisted pairs 115 are collectively arranged so as to force the elastic hollow filler 133 in a center direction in such a manner that directions formed by the conductors 121 of the respective twisted pairs 115 are different from each other. The four twisted pairs 115 are covered with the jacket 117 on the outer periphery thereof. This application is characterized in that the twisted pairs 115 are collectively arranged in such a manner that directions that the paired conductors 121 of the respective twisted pairs 115 are arranged, that is, directions 125a that centers of the paired conductors 121 are connected to each other, are different from each other. More specifically, at least the twisted pairs 115 adjacent to each other are different from each other in the direction that the conductors 121 thereof are arranged. The hollow filler 113 is composed of polyethylene and has an outer diameter of 0.9 to 1.2 mm and a thickness of 0.15 to 0.45 mm.

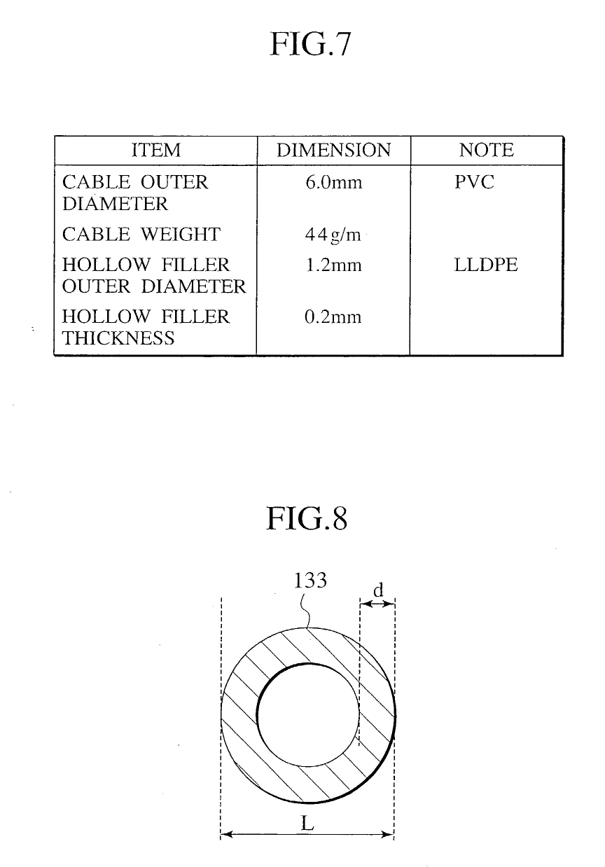

A cable specification of the LAN cable 131 with reference to FIG. 7 will be described. The outer diameter of the cable is 6.0 mm, for example. Preferably, the material of the jacket 117 is polyvinyl chloride (PVC), the recyclable eco material composed of the polyolefin material, and the NHPE material. The weight of the cable is 44 g/m, for example.

The hollow filler 133 is composed of polyethylene and has an outer diameter of 1.2 mm, for example and a thickness of 0.2 mm, for example. Polyethylene (PE) is classified into high density polyethylene (HDPE), low density polyethylene (LDPE), and linear low density polyethylene (LLDPE) according to the density thereof. For the hollow filler 133, linear low density polyethylene (LLDPE) is preferred.

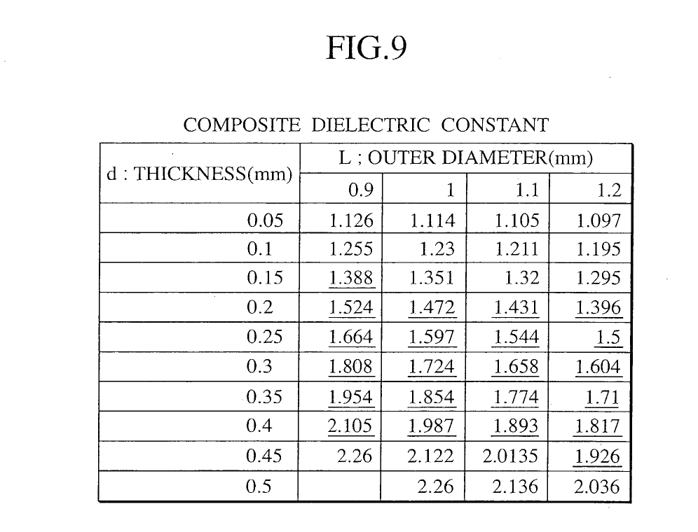

With reference to FIG. 8 and FIG. 9, a description will be made of a composite dielectric constant when the outer diameter and the thickness of the hollow filler 133 are varied. The hollow filler 133 has an outer diameter L and a thickness d as shown in FIG. 8. The dielectric constant of polyethylene is 2.26. FIG. 9 shows the composite dielectric constant of the hollow filler 133 shown in FIG. 8 as a function of the outer diameter L and the thickness d.

When the dielectric constant of the hollow filler 133 is less than 2, an excellent crosstalk characteristic can be obtained. Since the thickness d of the hollow filler 133 relates to a strength of the filler, combinations of the thickness d and the outer diameter L for values of the dielectric constant underlined in FIG. 9 are optimal for the hollow filler 133 based on a balance of the dielectric constant and the strength. It is revealed that the outer diameter L ranges from 0.9 to 1.2 mm and the thickness d ranges from 0.15 to 0.45 mm.

When a concentric cylinder includes two types of dielectrics like the hollow filler 133 and the center portion thereof contains air, the composite dielectric constant is expressed as follows based on a dielectric constant ε1 of polyethylene and a ratio K of cross-sectional areas of polyethylene and the air portion:

Composite dielectric constant=(ε1−ε)/(ε1−1)=K(3ε)/(2ε+1) (1)

With reference to FIGS. 6 to 9, a description will be made of the operational effect of the LAN cable 131 according to this embodiment. As shown in FIG. 6, the four twisted pairs 115 are prepared, each of which is formed by combining in parallel the two insulated wires 125 individually formed by covering the conductors 121 with the insulators 123. Simultaneously, the hollow filler 133 composed of the elastic body of tubular shape is prepared.

In particular, the hollow filler 133 is composed of polyethylene and has the outer diameter L of 0.9 to 1.2 mm and the thickness d of 0.15 to 0.45 mm and the dielectric constant thereof is less than 2. Therefore an excellent crosstalk characteristic can be thus obtained.

The four twisted pairs 115 are then collectively arranged around the hollow filler 133 in such a manner that the four twisted pairs 115 are pressed to be brought into contact with the hollow filler 133 and each contact portion is deformed into concave shape. The outer periphery of the collectively arranged four twisted pairs 115 is covered with the jacket 117 to form the LAN cable 131.

As a result, the four twisted pairs 115 and the hollow filler 133 are collectively arranged around the hollow filler 133 such that the twisted pairs 115 and the hollow filler 133 are in contact with each other or side pressure is applied thereto, and each twisted pairs 115 is held between the hollow filler 113 and the jacket 117. At this time, since the hollow filler 133 is adequately deformed by the side pressure applied to the hollow filler 133, the twisted pairs 115 can be prevented from moving in the plane direction intersecting the longitudinal direction. Accordingly, the disordered arrangement of the twisted pairs 115 can be prevented in any cross section in the longitudinal direction. Therefore, the distance between each of the twisted pairs 115 adjacent to each other does not change, thus preventing the deterioration of the crosstalk characteristic of the LAN cable 131.

The LAN cable 131 is provided with the hollow filler 133 with the outer diameter substantially equal to the size of the space which is created in the center portion when the four twisted pairs 115 are collected. Accordingly, the outer diameter of the cable does not increase compared to the conventional one.

Furthermore, in the case that the LAN cable 131 is provided with the hollow filler 133 with the diameter somewhat larger than the size of the space which is appeared in the center portion when the four twisted pairs 115 are collected, it is sufficient that the thickness d of the hollow filler 133 is adjusted such that the twisted pairs 115 forces the hollow filler 133 inside. Consequently, the outer diameter of the cable does not increase compared to the conventional one.

Since the four twisted pairs 115 can be collectively arranged using the hollow filler 133 with a hollow inside, the filler 133 can use a material of low dielectric constant, thus preventing the deterioration of the crosstalk characteristic of the LAN cable 131.

Consequently, according to the first aspect of the present invention, the plurality of twisted pairs and the hollow filler are collectively arranged around the hollow filler such that the twisted pairs and the hollow filler are in contact with each other or the side pressure is applied thereto, and the respective twisted pairs are held between the hollow filler and the jacket. Accordingly, the twisted pairs can be prevented from moving in the direction parallel to the cross section, and the disordered arrangement of the twisted pairs can be prevented in any cross section in the longitudinal direction. Therefore, the distances between the twisted pairs adjacent to each other do not change, thus preventing the deterioration of the crosstalk characteristics of the LAN cable.

Since the hollow filler is composed of polyethylene and has an outer diameter of 0.9 to 1.2 mm and a thickness of 0.15 to 0.45 mm, the dielectric constant thereof is set to be low, thus obtaining an excellent crosstalk characteristic.

Second Embodiment

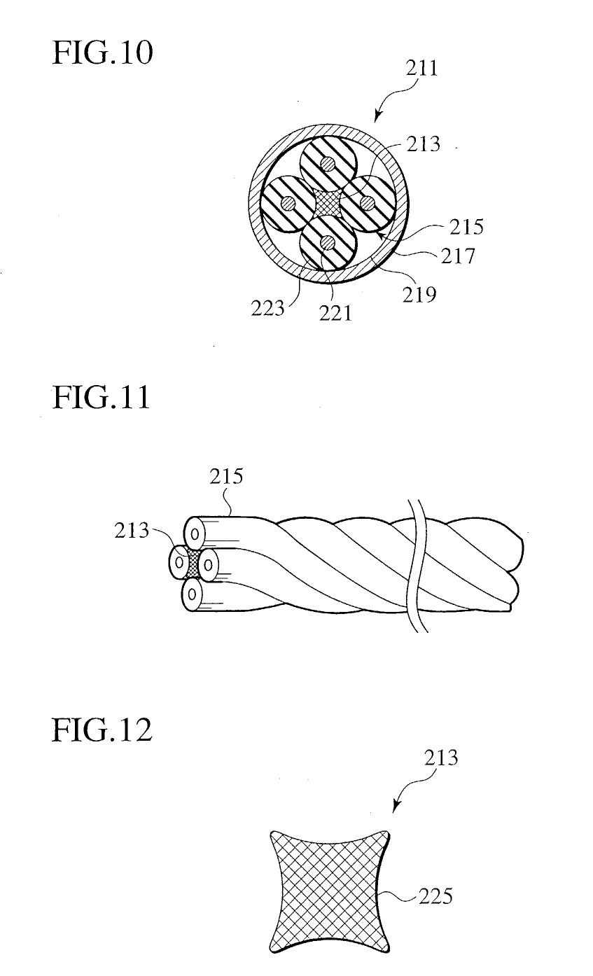

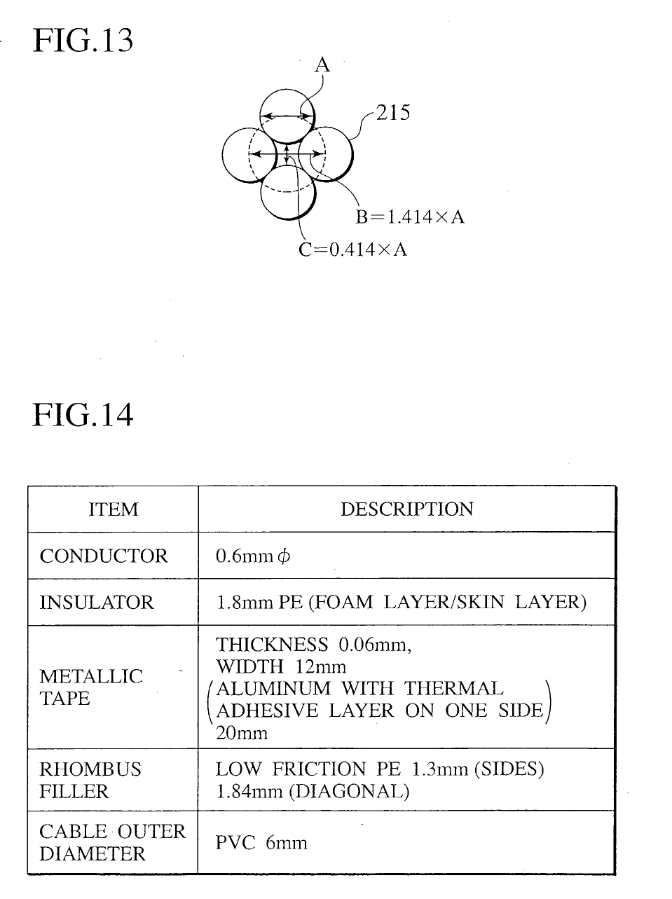

FIG. 10 shows a cross-sectional view showing a constitution of a data cable 211 according to an embodiment of the present invention. FIG. 11 is a side view of the data cable 211. FIG. 12 is a cross-sectional view of a rhombus filler 213. FIG. 13 is a view showing a correlation between the rhombus filler 213 and the insulated wires 215.

As shown in FIG. 10, the data cable 211 includes the insulated wires 215 arranged in four concave portions 225 provided for the rhombus filler 213 substantially shaped into a rhombus. The rhombus filler 213 and the insulated wires 215 are twisted together, and a metallic tape 219 is longitudinally attached to or wrapped around an outer periphery of the insulated wires 215. And, an outer periphery thereof is covered with a jacket 217.

As shown in FIG. 12, the rhombus filler 213 is provided with the four concave portions 225 each having a curvature substantially equal to a curvature of the insulated wires 215, or each having a curvature up to 1.5 times the curvature of the insulated wires 215.

FIG. 13 shows a case that the insulated wires 215 are in contact with each other in such a manner that virtual centers of the insulated wires 215 are arranged in vertices of a square, specifically, a case that each center of the insulated wires 215 are arranged on a circle for each 90 degrees, the circle having a diameter of B=A×1.414 for a diameter A of the insulated wires 215. The rhombus filler 213 is formed into a shape so as to fill a space appeared in the center portion of the insulated wires 215 collected in this case. Specifically, the rhombus filler 213 is formed such that distances between the concave portions 225 opposite to each other is C=A×0.414.

By forming this rhombus filler 213, a contact area of each concave portion 225 of the rhombus filler 213 and each insulated wire 215 is increased. Moreover, each insulated wire 215 is in contact with the adjacent insulated wires 215 without forcing out the adjacent insulated wires 215. Accordingly, the arrangement of the insulated wires 215 can be stabilized.

Referring to FIG. 10, each of the insulated wires 215 is formed by covering a conductor 221 with an insulator 223 such as resin. The insulated wires 215 are individually arranged in the concave portions 225 of the rhombus filler 213.

With reference to FIG. 14, a cable specification of the data cable 211 will be described. Each conductor 221 has a diameter of 0.6 mm, and each insulated wire 215 obtained by covering the conductor 221 with the insulator 223 has a diameter of 1.8 mm. The conductor 221 may use a silver-plated copper wire or the tin-plated copper plate. The conductor using such a copper wire has an effect to improve an amount of signal attenuation in high frequency. The insulated wire 215 may be composed of a twisted wire as well as a single wire.

Preferably, a material of the insulators 223 is polyethylene (PE) and has either a foam structure or a skin foam structure. The insulators 223 made of polyethylene (PE) are effective to improve the electric properties and the flexibility.

The metallic tape 219 is, for example, an aluminum tape, a copper tape, or the like with a thickness of 0.06 mm and a width of 12 mm. Preferably, the aluminum tape is provided with a resin layer or an adhesive layer on one side thereof to be easily wrapped and adhesion between the jacket 217 and the insulators 223 is thus increased. The wrapping pitch of the metallic tape 219 is set to, for example, 20 mm to increase the flexibility.

In the embodiment, the rhombus filler 213 has sides of 1.3 mm and diagonals of 1.84 mm. Preferably, the curvature of each concave portion is substantially equal to the curvature of the insulated wires 215, or up to 1.5 times the curvature of the insulated wires 215. The reason of setting the curvature to be up to the 1.5 times is that, with the curvature more than 1.5 times or over, the contact area with the insulated wires 215 is considerably decreased and a material cost is considerably increased. Moreover, when the curvature is not less than 1.5 times the curvature of the insulated wires 215, the cable diameter becomes larger than that of the conventional one, thus causing a problem of cable laying that the cable cannot be inserted into a wire duct.

Preferably, the material of the rhombus filler 213 is low friction polyethylene (PE). When using the low friction polyethylene, friction between the rhombus filler 213 and the insulated wires 215 can be considerably reduced. Therefore, in the manufacturing process, the difference in wire length caused by unbalanced feeding tension can be restored by tension within an elastic region of the insulated wires 215.

In case of the above condition, the outer diameter of the data cable 211 is substantially 6.0 mm. Preferably, the jacket 217 is composed of polyvinyl chloride (PVC) or the recyclable eco material composed of a polyolefin material. The eco material has been described in the first embodiment.

An operational effect of the data cable 211 will be described. The four insulated wires 215 are prepared, each of which is formed by covering the conductor 221 with the insulator 223. Subsequently, the insulated wires 215 are individually arranged in the concave portions 225 of the rhombus filler 213. The rhombus filler 213 and the insulated wires 215 are twisted together, and the aluminum tape 219 is wrapped around the outer periphery thereof to form a shielding layer. The outer periphery thereof is further covered with the jacket 217 to form the data cable 211.

The insulated wires 215 are arranged around the rhombus filler 213 provided with the four concave portions 225 each having a curvature substantially equal to the curvature of the insulated wires 215, and the insulated wires 215 are twisted with the rhombus filler 213. Accordingly, a centripetal force of the insulated wires 215 is enhanced and the contact area of the insulated wires 215 and the rhombus filler 213 is increased, so that the insulation wires 215 can be prevented from moving in the direction parallel to the cross section. Moreover, the protection of the outer periphery with the aluminum tape 219 and the jacket 217 has an effect to further prevent the movement of the insulated wires 215.

Since the material of the rhombus filler 213 is the low friction polyethylene (PE), the friction between the rhombus filler 213 and the insulated wires 215 can be considerably reduced. Accordingly, even if the feeding tension becomes unbalanced in the manufacturing process to cause the difference in wire length, the tension of the insulated wires 215 within the elastic region can restore the insulated wires 215, and the lowering of the skew characteristic can be prevented. The skew characteristic of the data cable of the present invention was measured as 20 ps/m.

According to the second aspect of the present invention, the insulated wires are arranged around the rhombus filler provided with the concave potions each having a curvature substantially equal to the curvature of the outer periphery of each insulated wire. The rhombus filler and the insulated wires are twisted together. The outer periphery thereof is shielded by the metallic tape and further covered with the jacket. Accordingly, the insulated wires 215 can be prevented form moving in the direction parallel to the cross section.

The contact area of the rhombus filler and each of the insulated wires is increased by setting the curvature of the concave portions to be larger than the curvature of the outer periphery of each insulated wire up to 1.5 times the curvature of the same. Accordingly, the insulated wires can be prevented from moving the insulated wires in the direction parallel to the cross section. Moreover, the increase of the material cost can be suppressed, and the cable can be inserted through a specified wire duct.

The rhombus filler is provided with the concave portions on the four sides, each concave portion having a curvature substantially equal to the curvature of the outer periphery of each insulated wire. The distances of the concave portions facing each other are set to be 0.414 times the diameter of the insulated wires. Furthermore, the rhombus filler is formed such that the centers of the insulated wires are arranged on the circle with a diameter of 1.414 times the diameter of the insulated wires when the insulated wires are arranged in the concave portions. Accordingly, the insulated wires 215 can be prevented from moving in the direction parallel to the cross section. Furthermore, since the difference in wire length between the insulated wires can be made substantially zero, the skew characteristic can be improved.

Third Embodiment

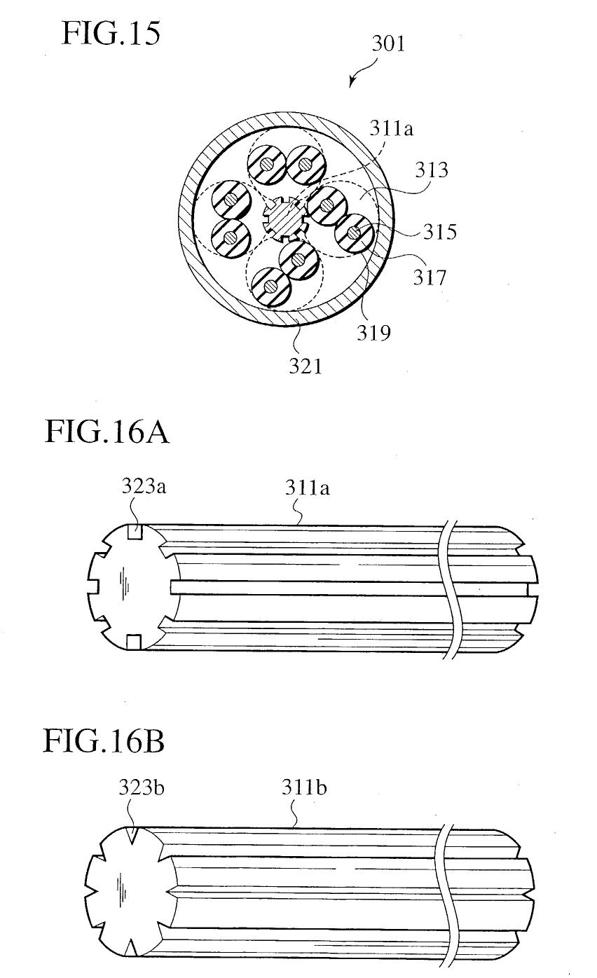

FIG. 15 is a cross-sectional view showing a constitution of a data transmission cable according to a third embodiment of the present invention. FIGS. 16A and 16B are cross-sectional views respectively showing constitutions of grooved fillers 311a and 311b provided with a LAN cable 301.

In the LAN cable 301, four twisted pairs 313 are collectively arranged around the grooved filler 311a. The grooved filler 311a is provided with a plurality of concave grooves on an outer periphery of a filler with a substantially round section. The grooved filler 311a and the twisted pairs 313 are twisted together in the same direction, and the outer periphery thereof is covered with a jacket 321.

In the grooved filler 311a shown in FIG. 16A, eight horseshoe-shaped grooves are formed on the outer periphery of the round filler of tubular shape in the longitudinal direction. In this embodiment, the number of horseshoe-shaped grooves 323a is eight, but the number thereof is not limited to this and may be more than eight and over. In the grooved filler 311b shown in FIG. 16B, eight V-shaped grooves are formed on the outer periphery of the round filler of tubular shape in the longitudinal direction. In this case, the number of V-shaped grooves 323b is also eight, but the number thereof is not limited to this and may be more than eight and over.

Each of the outer diameters of the grooved fillers 311a and 311b is set regardless of the shape of the grooves as follows. When the four twisted pairs 313 with a same diameter are collectively arranged in a circular shape, a theoretical circle is formed in a space as a circle concentric with the circular shape so as to be in contact with the twisted pairs 313. The outer diameter is set to be substantially equal to the diameter of the circle thus formed.

Turning to FIG. 15, each of the twisted pairs 313 is formed by covering the center conductor 315 with the insulator 317. The twisted pairs 313 are arranged to be accommodated in the grooves 323a of the grooved fillers 311a.

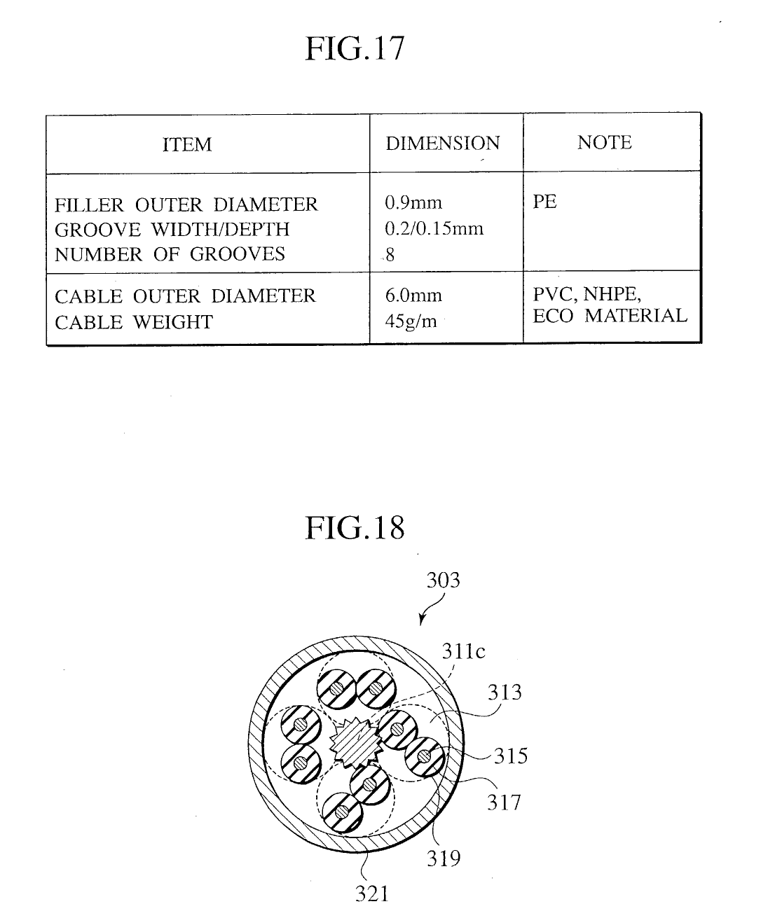

With reference to FIG. 17, a description will be made of a cable specification of the LAN cable 301 provided with the four twisted pairs 313. The outer diameters of the grooved fillers 311a and 311b are, for example, 0.9 mm. Preferably, the material thereof is polyethylene or the like. The grooves 323a and 323b provided on the outer periphery of the grooved fillers 311a and 311b have a width of 0.2 mm and a depth of 0.15 mm, for example. Such eight grooves 323a and 323b are formed on the outer periphery of the respective fillers. Use of the polyethylene foam (PE) or the like allows the dielectric constant to be lowered and has an effect on improvement of the flexibility.

The outer diameter of each center conductor 315 is, for example, 0.6 mm, not shown in FIG. 17. The outer diameter of each insulated wire 319 formed by covering the center conductor 315 with the insulator 317 is, for example, 1.4 mm. The outer diameter of the trajectory of each twisted pair formed by twisting the two insulated wires 319 becomes 2.8 mm.

The outer diameter of the LAN cable 301 formed by arranging the four twisted pairs 313 in the grooves 323a of the grooved filler 311a is, for example, 6.0 mm. In this case, preferably, the material of the jacket 321 is polyvinyl chloride (PVC), the recyclable eco material composed of a polyolefin material, and the NHPE material. The cable weight of the LAN cable 301 is, for example, 45 g/m. The eco material is similar to that of other embodiments.

Preferably, the center conductors 315 use the silver-plated copper wire, the tin-plated copper wire, or the like. Use of the silver-plated copper wire is effective to improve the signal attenuation amount in high frequency. Moreover, polyethylene foam as the material of the insulators 317 is effective to lower the dielectric constant and to improve the flexibility.

Preferably, the metallic tape 319 is, for example, an aluminum tape or a copper tape with a thickness of 0.06 mm and a width of 12 mm, not shown in FIG. 17. The aluminum tape may be provided with a resin layer or coated with an adhesive on one side to be easily wrapped, and adhesion between the jacket 321 and the insulators 317 may be thus improved.

With reference to FIG. 15, a description will be made of an operational effect of the LAN cable 301. First, the four insulated wires 313 are prepared, each of which is formed by twisting the two insulated wires 319 individually formed by covering the center conductor 315 with the insulator 317. Subsequently, the four twisted wires 313 are collectively arranged around the grooved filler 311a. The grooved filler 311a and the twisted pairs 313 are twisted together in the same direction, and the outer periphery thereof is then covered with the jacket 321 to form the LAN cable 301.

Note that, after the grooved filler 311a and the twisted pairs 313 are twisted together in the same direction, a metallic tape, not shown in FIG. 15, may be longitudinally attached to or wrapped in a spiral around the outer periphery thereof. Accordingly, the shielding effect of the twisted pairs 313 can be enhanced, and the metallic tape has an effect on shielding of electric noises received from the outside.

Consequently, since the grooved filler 311a is provided, the twisted pairs 313 can be arranged in the horseshoe-shaped grooves 323a provided on the outer periphery of the grooved filler 311a. Accordingly, the twisted pairs 313 can be prevented from moving in the direction parallel to the cross section.

Since the plurality of horseshoe-shaped grooves 323a provided on the outer periphery of the grooved filler 311a serve as resistance to the movement of the twisted pairs 313 in the circumferential direction, the distances between the twisted pairs 313 adjacent to each other can be maintained constant.

Accordingly, since the movement parallel to the cross section can be reduced, the distances between the twisted pairs 313 can be maintained constant, and deterioration of the crosstalk characteristic between the twisted pairs 313 can be reduced.

Since the grooved filler 311a and the twisted pairs 313 are twisted together in the same direction, the centripetal force is generated in the center direction of the grooved filler 311a, and the adhesion between the twisted pairs 313 and the grooved filler 311a is increased, thus stabilizing the arrangement of the twisted pairs 313. Therefore, the deterioration of the crosstalk characteristic between the twisted pairs 313 can be reduced.

Since the grooved filler 311a and the twisted pairs 313 are twisted together in the same direction, the LAN cable 301 becomes excellent in flexibility and becomes easy to be bent. Accordingly, the LAN cable 301 can flexibly respond to an environmental state in cable laying.

The outer diameter of the grooved filler 311a is set to be substantially equal to the mean diameter of the space which is formed in the center when the four twisted pairs 313 with the same outer diameter are collectively arranged in a circular form, and the outer diameter of the LAN cable 301 can be minimized. Accordingly, the LAN cable can be prevented from being depart from the cable standard.

Since the grooved filler 311a is provided, the distances between the twisted pairs 313 can be stably maintained, thus preventing the deterioration of the crosstalk characteristic. In order to reduce the crosstalk, the difference of the twist pitch between the twisted pairs has been hitherto increased. However, the need for increasing the difference of the twist pitch is eliminated, and the twisted wires 313 can be manufactured to have a substantially same twist pitch. Accordingly, the manufacturing line speed is increased and further the manufacturing costs can be reduced.

In this embodiment, the description has been made of the grooved filler 311a having the horseshoe-shaped grooves 323a. However, even if the grooved filler 311b including the V-shaped grooves 323b is arranged instead of the grooved filler 311a, similar effects to the above embodiment can be also obtained.

FIG. 18 is a sectional view showing a constitution of a LAN cable 303 according to a modification of the third embodiment of the present invention. The LAN cable 303 is characterized by including a star filler 311c with an asterisk form instead of the grooved filler 311a in the data transmission cable 301 in FIG. 15.

In the LAN cable 303, the four twisted pairs 313 are collectively arranged around the star filler 311c having a number of V-shaped grooves on an outer periphery of a filler with a substantially round section. The star filler 311c and the twisted pairs 313 are twisted together in the same direction, and the outer periphery thereof is then covered with the jacket 321.

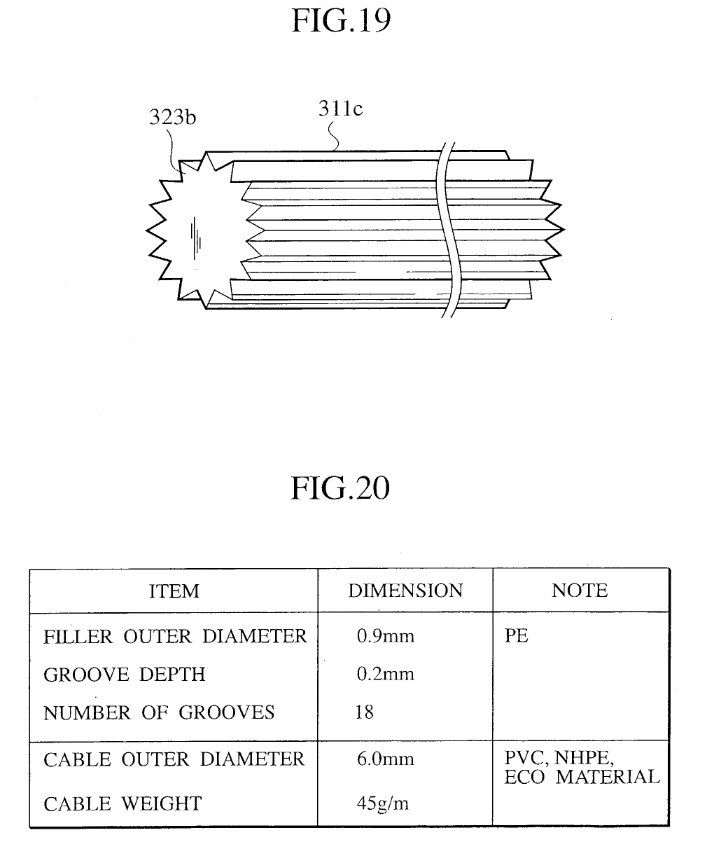

As shown in FIG. 19, in the star filler 311c, a number of V-shaped grooves 323b are continuously formed on the outer periphery of the round filler of tubular shape. The outer diameter of the star filler 311c is set regardless of the shape of the grooves as follows. When the four twisted pairs 313 with a same diameter are collectively arranged in a circular shape, a theoretical circle is formed in a space as a circle concentric with the circular shape so as to be in contact with the twisted pairs 313. The outer diameter is set to be substantially equal to the diameter of the circle thus formed.

With reference to FIG. 20, a description will be made of a cable specification of the LAN cable 303 provided with the four twisted pairs 313. The outer diameter of the star filler 311c is, for example, 0.9 mm. Preferably, the material thereof is polyethylene (PE) or the like. The grooves 323b formed on the outer periphery of the star fillers 311c have a depth of 0.2 mm. The eighteen grooves 323b are formed on the outer periphery of the filler. Use of the polyethylene foam (PE) or the like for the material of the star filler 311c allows the dielectric constant to be lowered and is effective to improve the flexibility.

The outer diameter of each center conductor 315 is, for example, 0.6 mm, not shown in FIG. 17. The outer diameter of each insulated wire 319 formed by covering the center conductor 315 with the insulator 317 is, for example, 1.4 mm. The outer diameter of the twisted pair formed by twisting the two insulated wires 319 becomes 2.8 mm.

The outer diameter of the LAN cable 303 formed by arranging the four twisted pairs 313 around the star filler 311c is, for example, 6.0 mm. In this case, preferably, the material of the jacket 321 is polyvinyl chloride (PVC), the recyclable eco material composed of the polyolefin material, and the NHPE material. The cable weight of the LAN cable 303 is, for example, 45 g/m.

Meanwhile, preferably, the center conductors 315 use the silver-plated copper wire, the tin-plated copper wire, or the like. Use of the silver-plated copper wire is effective to improve the signal attenuation amount in high frequencies. Moreover, polyethylene foam as the material of the insulators 317 is effective to lower the dielectric constant and to improve the flexibility.

After the star filler 311c and the twisted pairs 313 are twisted together in the same direction, a metallic tape, not shown in FIG. 18, may be longitudinally attached to or wrapped in a spiral around the outer periphery thereof. Accordingly, since the shielding effect of the twisted pairs 313 can be enhanced, the metallic tape has an effect on shield of electric noises received from the outside.

With reference to FIG. 18, an operational effect of the LAN cable 303 will be described. First, the four twisted pairs 313 are prepared, each of which is formed by twisting the two insulated wires 319, each formed by covering the center conductor 315 with the insulator 317. Subsequently, the four twisted wires 313 are collectively arranged around the star filler 311c. The star filler 311c and the twisted pairs 313 are twisted together in the same direction, and the outer periphery thereof is then covered with the jacket 321 to form the LAN cable 303.

Consequently, since the star filler 311c is provided, the twisted pairs 313 can be arranged in the V-shaped grooves 323b provided on the outer periphery of the star filler 311c. Accordingly, the twisted pairs 313 can be prevented from moving in the direction parallel to the cross section.

Since a number of V-shaped grooves 323b provided on the outer periphery of the star filler 311c serve as resistance to the movement of the twisted pairs 313 in the circumferential direction, the distances between the twisted pairs 313 adjacent to each other can be maintained constant.

Since the movement parallel to the cross section can be reduced, the distances between the twisted pairs 313 can be maintained constant, thus preventing the deterioration of the crosstalk characteristic between the twisted pairs 313.

Since the star filler 311c and the twisted pairs 313 are twisted together in the same direction, the centripetal force is generated in the center direction of the star filler 311c, and the adhesion between the twisted pairs 313 and the star filler 311c is increased, thus stabilizing the arrangement of the twisted pairs 313. Accordingly, the deterioration of the crosstalk characteristic between the twisted pairs 313 can be reduced.

Furthermore, since the star filler 311c and the twisted pairs 313 are twisted together in the same direction, the LAN cable 303 becomes excellent in flexibility and becomes easy to be bent. Accordingly, the LAN cable 303 can flexibly respond to an environmental state in cable laying.

Since the sectional area of the star filler 311c is set to be substantially equal to the area of the space which is formed in the center when the four twisted pairs 313 are collectively arranged in a doughnut form, the outer diameter of the LAN cable 303 can be minimized, thus preventing the LAN cable from being different from the cable standard.

Further more, since the distances between the twisted pairs 313 can be stably maintained, the need for designedly varying the twist pitch in twisting of the twisted pairs is eliminated. Accordingly, the twist pitch can be set to be somewhat longer to increase the manufacturing line speed, thus contributing to reduction of the manufacturing costs.

According to the third aspect of the present invention, in the data transmission cable, the four twisted pairs are arranged around the grooved filler provided with the plurality of concave grooves on the outer periphery of the round filler. Since the frictional resistance is increased by the grooves provided on the grooved filler, the twisted pairs can be prevented from moving in parallel to the cross section, thus preventing the disordered arrangement and the deterioration of the crosstalk characteristic. Moreover, since the difference of the twist pitch between the twisted pairs can be reduced due to the prevention of the disordered arrangement, the manufacturing line speed of the twisted pairs can be increased, thus reducing the manufacturing costs.

Since the outer diameter of the grooved filler is set to be substantially equal to the mean diameter of the center circular space formed by collectively arranging the four twisted pairs, the outer diameter of the LAN cable can be minimized. Accordingly, the cable outer diameter can be prevented from being different from the standard.

Since the grooved filler and the twisted pairs are twisted together after the twisted pairs are collectively arranged around the grooved filler, the adhesion between the twisted pairs and the filler can be improved, thus further stabilizing the arrangement of the twisted pairs. Accordingly, the deterioration of the crosstalk characteristic can be further reduced.

Furthermore, after the twisted pairs are arranged in the grooves to be united, the outer periphery of the unitized wire is covered with the metallic tape. Accordingly, the twisted pairs are less subjected to electric induction from the outside, thus improving the electric properties of the LAN cable. Note that 415a denotes a trajectory of the outer edge of the twisted pair 415.

Fourth Embodiment

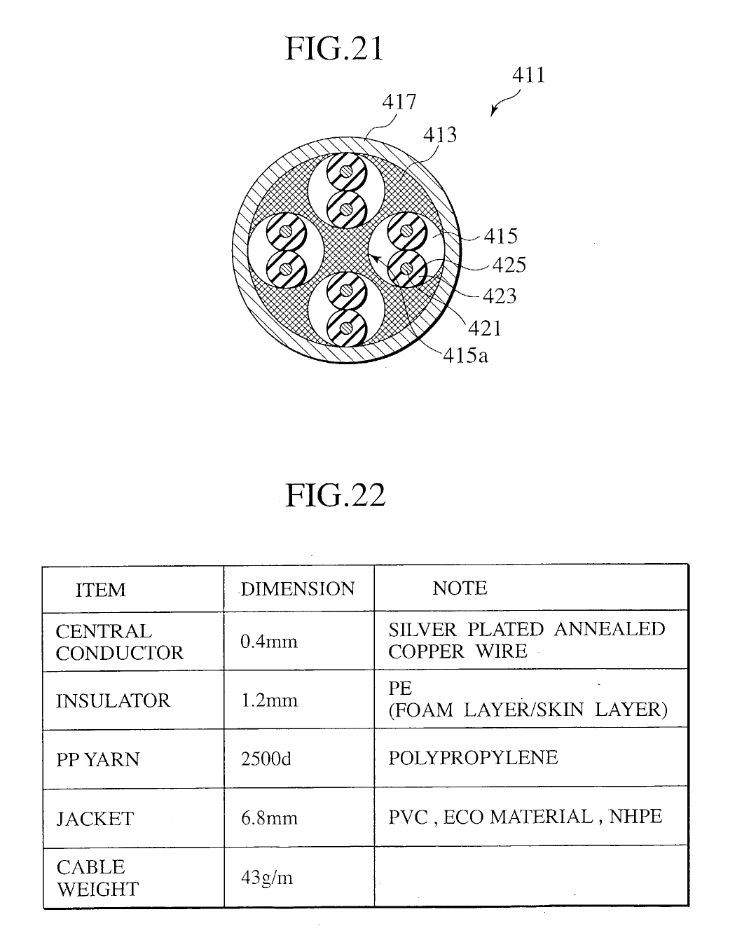

FIG. 21 is a view showing a constitution of a data transmission cable according to a fourth embodiment of the present invention. In a LAN cable 411, four twisted pairs 415 are accommodated and arranged so as to squeeze a PP yarn 413 to be a buffer layer in the center direction. The outer periphery thereof is covered with a jacket 417 in such a manner that the four twisted pairs 415 are enveloped by the PP yarn 413. Each of the twisted pairs 415 is formed by twisting two insulated wires 425. Each of the insulated wires 425 is formed by covering a center conductor 421 with an insulator 423 such as resin.

With reference to FIG. 22, a cable specification of the LAN cable 411 will be described. Each center conductor 421 may be composed of either a single wire or a twisted wire. Use of the silver-plated annealed copper wire or tin-plated copper wire is effective to improve the amount of attenuation in high frequency. Each insulator 423 is composed of the foam structure of polyethylene foam (PE) or the skin foam structure of polyethylene and effective to improve the electric properties and the flexibility.

The PP yarn 413 is a cord-like buffer layer composed of polypropylene with a denier of 2500 d. The denier indicates a thickness of a fiber. The PP yarn 413 is resistant to tension in the longitudinal direction while the PP yarn 413 can be easily split in the longitudinal direction. The buffer layer reduces stress generated between the twisted wires 415 and accommodates and arranges the four twisted pairs 415 in an enveloping manner.

The outer diameter of the jacket 417 is, for example, 6.8 mm. Preferably, the material of the jacket 417 is polyvinyl chloride (PVC), the recyclable eco material composed of the polyolefin material, and the non-halogen flame-retardant material. The weight of the cable is, for example, 43 g/m. The eco material is similar to that described in the first embodiment.

With reference to FIGS. 21 and 22, an operational effect of the LAN cable 411 will be described. First, as shown in FIG. 21, the four insulated wires 415 are prepared, each of which is formed by combining the two insulated wires 425, each formed by covering the center conductor 421 with the insulator 423. Simultaneously, an amount (2500 d) of the PP yarn 413 is prepared, which can fill a space formed in the center portion by trajectories 415a of the outer peripheries of the twisted pairs 415 formed by two of the twisted pairs 415 and the jacket 417 when the four twisted pairs 415 are collectively arranged.

Subsequently, the four twisted pairs 415 are accommodated and arranged so as to be squeezed around the PP yarn 413 to be the buffer layer, so that the buffer layer lies for buffering in the center portion where the four twisted pairs 413 are closed to each other and envelops the respective twisted pairs. Furthermore, the outer periphery thereof is covered with the jacket 417 such that the four twisted pairs 415 are enveloped in the PP yarn 413 as the buffer layer, thus forming the LAN cable 411.

As a result, the PP yarn 413 lies as the buffer layer in the center portion where the four twisted pairs 415 are closed to each other and in the four spaces, each formed by two of the twisted pairs 415 and the jacket 417. Accordingly, the distances between the twisted pairs can be maintained constant, thus preventing the deterioration of the crosstalk characteristic.

Since the PP yarn 413 is flexible compared to a conventional filler made of resin, even if the cable is held down, the twist of the twisted pairs is not disturbed. The deterioration of the electric properties caused by the disturbed twist of the twisted pairs can be prevented.

When the PP yarn of high denier is used, the PP yarn 413 extruded to the outer periphery portion prevents a dent of the covering material in extrusion of the jacket 417. Accordingly, the cross section of the cable can be maintained in a circular form.

Furthermore, since the PP yarn is cheaper than the filler made of resin, the PP yarn can contribute to reduction of the manufacturing cost.

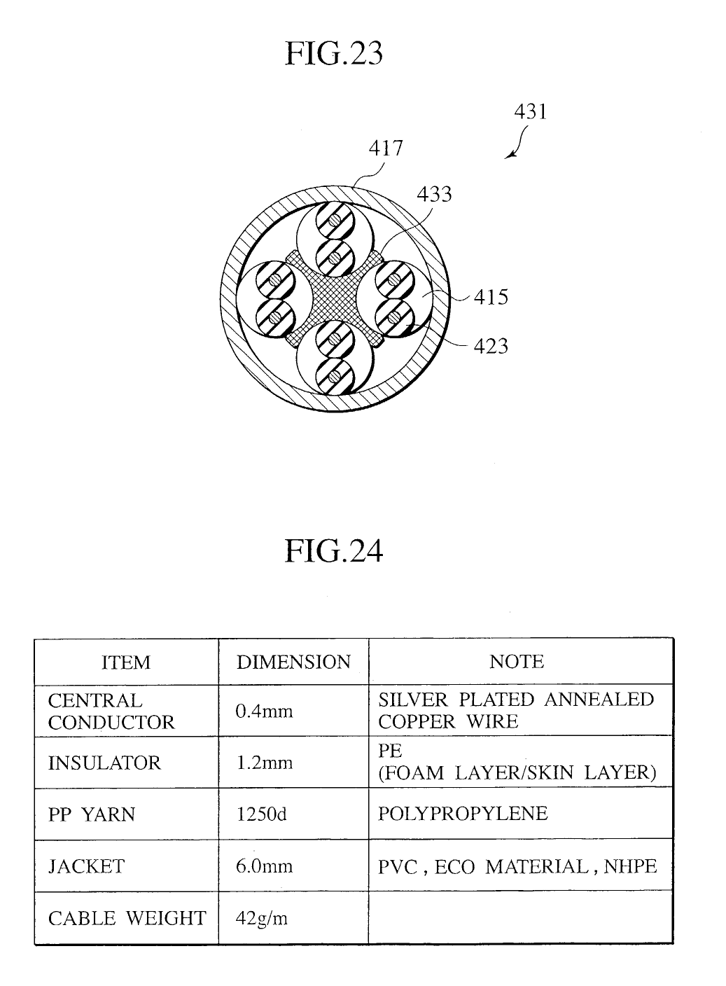

FIG. 23 is a constitution of a data transmission cable according to a modification of the forth embodiment of the present invention. In a LAN cable 431, the four twisted pairs 415 are collectively arranged around a PP yarn 433 to be the buffer layer, and the outer periphery thereof is covered with the jacket 417.

With reference to FIG. 24, a cable specification of the LAN cable 431 will be described. The cable specification of the LAN cable 431 shown in FIG. 24 contains similar part to the cable specification of the LAN cable 411 shown in FIG. 22, and the description thereof will be omitted.

The PP yarn 433 is a cord-like buffer layer composed of polypropylene with a denier of 1250 d. The denier indicates a thickness of a fiber. The PP yarn 433 is resistant to tension in the longitudinal direction while the PP yarn 433 can be easily split in the longitudinal direction. In the buffer layer, stress generated between the twisted wires 415 is reduced, and the four twisted pairs 415 are accommodated and arranged.

The outer diameter of the jacket 417 is, for example, 6.0 mm. Preferably, the material of the jacket 417 is polyvinyl chloride (PVC), the recyclable eco material composed of the polyolefin material, and the non-halogen flame-retardant material. The weight of the cable is, for example, 42 g/m.

With reference to FIGS. 23 and 24, an operational effect of the LAN cable 431 will be described. First, as shown in FIG. 23, the four insulated wires 415 are prepared, each of which is formed by combining in parallel the two insulated wires 425, each formed by covering the center conductor 421 with the insulator 423. Simultaneously, an amount (1250 d) of the PP yarn 433 is prepared, which can fill a space formed in the center portion formed by the twisted pairs 415 when the four twisted pairs 415 are collectively arranged.

Subsequently, the four twisted pairs 415 are collectively arranged so as to squeeze the PP yarn 433 to be the buffer layer around the PP yarn 433, so that the buffer layer lies for buffering in the center portion where the four twisted pairs 415 are closed to each other. Furthermore, the outer periphery thereof is covered with the jacket 417 to envelop the four twisted pairs 415, thus forming the LAN cable 431.

Since the PP yarn 433 lies as the buffer layer in the center portion formed by the four twisted wires 415, the distances between the twisted pairs can be maintained constant, thus preventing the deterioration of the crosstalk characteristic.

Since the PP yarn 433 is flexible compared to a conventional filler made of resin, even if the cable is held down, the twist of the twisted pairs is not disturbed. The deterioration of the electric properties caused by the disturbed twist of the twisted pairs can be prevented.

Furthermore, when the PP yarn 433 of high denier is used, the PP yarn extruded to the outer periphery portion prevents a dent of the covering material in extrusion of the jacket 417. Accordingly, the cross section of the cable can be maintained in a circular form. Since the PP yarn is cheaper than the filler made of resin, the PP yarn 433 can contribute to reduction of the manufacturing cost.

According to the forth aspect of the present invention, the buffer layer lies for buffering in the portion where the plurality of twisted pairs are closed to each other and envelops the twisted pairs. The jacket covers the buffer layer on the outer periphery. Accordingly, the distances between the twisted pairs can be maintained constant, thus preventing the deterioration of the crosstalk characteristic. Even if the cable is held down, the twist of the twisted pairs is not disturbed, and the deterioration of the electric properties caused by the disturbed twist of the twisted wires can be prevented.

And, the buffer layer lies for buffering in the portion where the plurality of twisted pairs are closed to each other, and the jacket covers the buffer layer on the outer periphery. Accordingly, the distance between the twisted pairs can be maintained constant, thus preventing the deterioration of the crosstalk characteristic. Even if the cable is held down, the twist of the twisted pairs is not disturbed, and the deterioration of the electric properties caused by the disturbed twist of the twisted wires can be prevented.

Fifth Embodiment

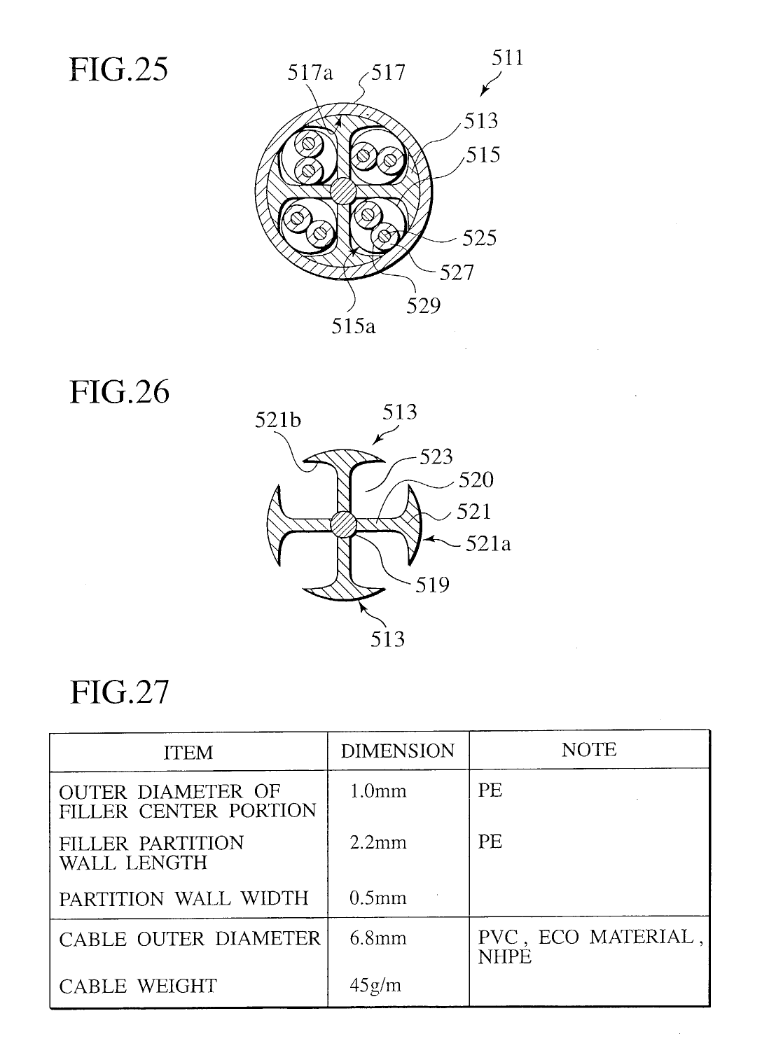

FIG. 25 is a cross-sectional view showing a constitution of a data transmission cable according to a fifth embodiment of the present invention. FIG. 26 is a sectional view showing a constitution of an anchor filler 513 according to this embodiment.

In a LAN cable 511, four twisted pairs 515 are collectively arranged around the anchor filler 513 with a substantially anchor shaped cross section, and an outer periphery thereof is covered with a jacket 517. As shown in FIG. 26, in the anchor filler 513, four anchor-shaped end portions 521 are formed so as to radially extend from a filler center portion 519 in four directions. Each space 523 is formed between two of the end portions 521 radially extending from the filler center portion 519 so as to be orthogonal to each other. The twisted pairs 515 are squeezed to be inserted into the spaces 523 from the outside.

Specifically, the anchor filler 513 includes partition walls 520 projecting outward while the adjacent partition walls 520 form an angle of 90 degrees. The anchor filler 513 includes an end portion 521 at an end of each of the partition walls 520. The end portion 521 includes a circumscribed surface 521a and an inscribed surface 521b. The circumscribed surface 521a is circumscribed to the inner surface 517a at a curvature substantially equal to a curvature of an inner surface 517a of the jacket 517. The inscribed surface 521b is inscribed to the twisted pair 515 at a curvature substantially equal to a curvature of a trajectory 515a of an outer edge of each twisted pair 515. And, the anchor filler 513 includes the four spaces 523 between the adjacent partition walls 520 and between the adjacent end portions 521 to accommodate and arrange the twisted pairs 515.

Turning to FIG. 25, each of the twisted pairs 515 is formed by twisting the two insulated wires 529. Each of the insulated wires 529 is formed by covering center conductor 525 with an insulator 527 such as resin. The respective twisted pairs 515 are accommodated and arranged in the spaces 523 of the anchor filler 513.

With reference to FIG. 27, a cable specification of the LAN cable 511 will be described. The outer diameter of the filler center portion 319 is, for example, 1.0 mm. Preferably, the material thereof is polyethylene (PE). Each partition wall 520 has, for example, a length of 2.2 mm and a width of 0.5 mm. Preferably, the material thereof is polyethylene (PE). In this case, the cable outer diameter is, for example, 6.8 mm. Preferably, the material of the jacket 517 is polyvinyl chloride (PVC), the recyclable eco material composed of the polyolefin material, or the NHPE material. The weight of the cable is, for example, 45 g/m. The eco material has been already described in the first embodiment.

With reference to FIG. 25, an operational effect of the LAN cable 511 will be described. First, the four twisted pairs 515 are prepared, each of which is formed by twisting the two insulated wires 529, each formed by covering the center conductor 525 with the insulator 527. Subsequently, the twisted pairs 515 are accommodated and arranged in the respective spaces 523 of the anchor filler 513. At last, the outer periphery thereof is covered with the jacket 517 to form the LAN cable 511.

Consequently, by using the anchor filler 513, the twisted pairs 515 are accommodated and arranged in the four spaces 523, each having a shape substantially equal to the outline of the twisted pairs 515, and the twisted pairs 515 can be individually held between the two partition walls 520 and the jacket 517. Accordingly, the twisted pairs 515 can be prevented from moving in the direction parallel to the cross section.

Since the anchor filler 513 includes the circumscribed surface 521a of the end portion 521 which is circumscribed to the jacket 517 at the a curvature substantially equal to the curvature of the inner surface of the jacket 517, the twisted pairs 515 can be prevented from moving in the direction parallel to the cross section.

Furthermore, each of the end portions 521 of the anchor filler 513 includes the inscribed surface 521b inscribed to the twisted pair 515 at a curvature substantially equal to the trajectory 515a of the outer edge of each twisted pair 515, the twisted pairs 515 can be prevented from moving in the direction parallel to the cross section.

Accordingly, the distances in the cross-sectional direction between the twisted pairs 515 can be maintained longer than the conventional one, and the twist pitch can be set longer. Therefore, the manufacturing line speed in twisting can be increased, thus allowing for reduction of costs.

The circumscribed surface 521a of each end portion 521 of the anchor filler 513 has a width larger than that of the conventional cross-shaped filler 827, and has an enveloping shape with a curvature substantially equal to the curvature of the inner surface 517a of the jacket 517. Accordingly, the jacket 517 is not dented in extrusion of the jacket 517. Moreover, the anchor filler 513 has an excellent accommodating capability, so that the LAN cable 511 can be formed to have a round section.

Consequently, the distances between the twisted pairs 515 adjacent to each other do not vary, thus preventing the deterioration of the crosstalk characteristic of the LAN cable 511.

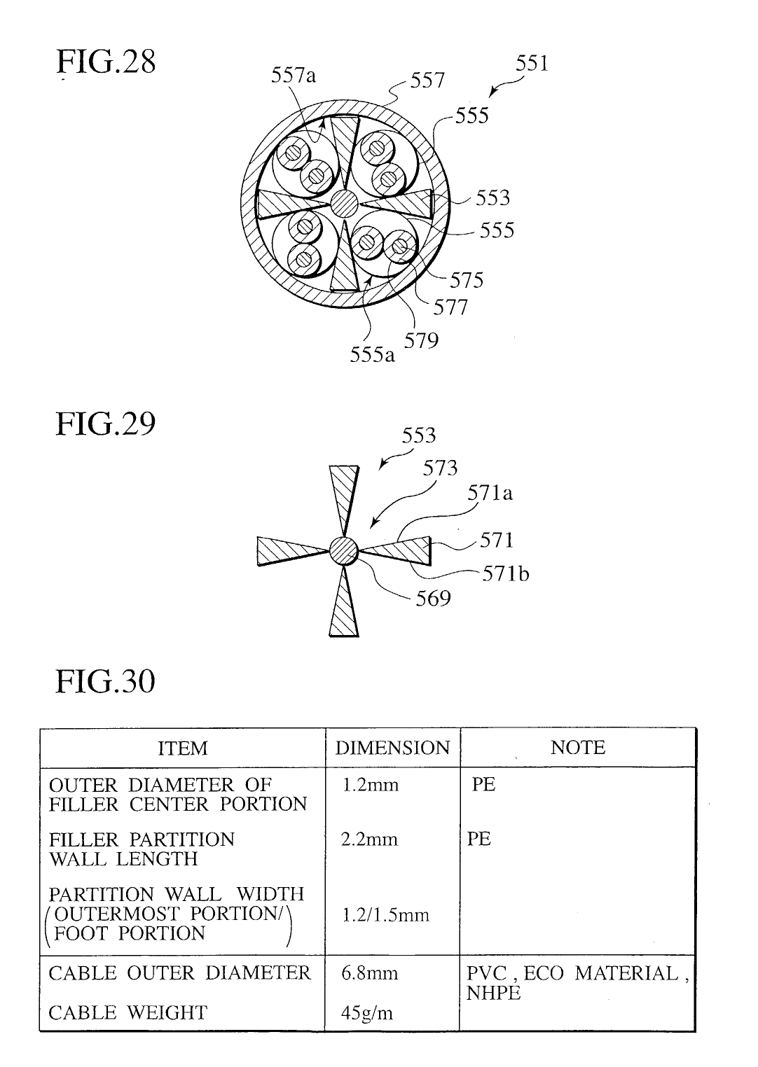

FIG. 28 is a cross-sectional view showing a constitution of a data transmission cable according to a modification of the fifth embodiment of the present invention. FIG. 29 is a cross-sectional view showing a constitution of a windmill filler 553. In a LAN cable 551, four twisted pairs 555 are collectively arranged around the windmill filler 553 with a substantially sector cross section, and an outer periphery thereof is covered with a jacket 557. As shown in FIG. 29, in the windmill filler 553, four sector-shaped end portions 571 are formed so as to radially extend from a filler center portion 569 in four directions. Each space 573 is formed between the two end portions 571 radially extending from the filler center portion 569 so as to be orthogonal to each other. The twisted pairs 555 are squeezed to be inserted into the spaces 573 from the outside.

Specifically, the windmill fillers 553 includes four sector-shaped partition walls 571 widening toward the outside. Each of the partition walls 571 includes partition wall surfaces 571a and 571b circumscribed to the twisted pairs 555. The windmill filler 553 includes the four sector-shaped spaces 573 of for accommodating and arranging the twisted pairs. When each twisted pair 555 is accommodated and arranged in the space 573, the trajectory 555a of the outer edge of the twisted pair 555 is tangent to the partition wall surfaces 571a and 571b and an inscribed surface 557a of the jacket 557.

Referring to FIG. 28, each twisted pair 555 is formed by twisting the two insulated wires 579, each formed by covering a center conductor 575 with an insulator 577 such as resin. The twisted pairs 555 are accommodated and arranged in the respective spaces 573.

With reference to FIG. 30, a cable specification of the LAN cable 551 will be described. The outer diameter of the filler center portion 569 is, for example, 1.2 mm. Preferably, the material thereof is polyethylene (PE). Each partition wall 571 has a length of, for example 2.2 mm. Preferably, the material thereof is polyethylene (PE). The width of the partition wall 571 is, for example, 1.2 mm at the outermost portion in contact with the inscribed surface 557a of the jacket 557 and, for example, 0.5 mm at the foot portion tangent to the filler center portion 569. In this case, the cable outer diameter is, for example, 6.8 mm. Preferably, the material of the jacket 557 is polyvinyl chloride (PVC), the recyclable eco material composed of the polyolefin material, or the NHPE material. The weight of the cable is, for example, 45 g/m.

With reference to FIG. 28, an operational effect of the LAN cable 551 will be described. First, the four twisted pairs 555 are prepared, each of which is formed by twisting the two insulated wires 579, each formed by covering the center conductor 575 with the insulator 577. Subsequently, the twisted pairs 555 are accommodated and arranged in the respective spaces 573 of the windmill filler 553. At last, the outer periphery thereof is covered with the jacket 557 to form the LAN cable 551.

Consequently, by using the windmill filler 553, the twisted pairs 555 are accommodated and arranged in the respective four sector spaces 573, so that each of the twisted pairs 555 can be held between the two partition walls 571 and the jacket 557. Accordingly, the twisted pairs 555 can be prevented from moving in the direction parallel to the cross section.

Accordingly, since the twisted pairs 555 are held by the partition walls 571 widening toward the outside, the twisted pairs 555 can be prevented from moving in the horizontal direction with respect to the cutting plane. Since the relative distances between the twisted pairs are constant, the conventional deterioration of the crosstalk characteristic can be prevented.

Since the distances between the twisted pairs 555 can be maintained longer than the conventional one, the twist pitch can be set longer. Consequently, the manufacturing line speed can be increased, thus contributing to reduction of the costs. Furthermore, since the foot portions of the partition walls 571 are made thin and easily inclined, the windmill filler can flexibly response to variation of state of the twisted pairs 555 when the twisted pairs 555 are collectively arranged. The windmill filler is excellent in flexibility because of the thin foot portions of the partition walls 571, and the cable is easy to be bent.

According to the fifth aspect of the present invention, since the twisted pairs can be accommodated and arranged in the spaces of a shape substantially equal to the contour of the twisted pairs with the anchor filler, the twisted pairs can be prevented from moving in the direction parallel to the cross section. Consequently, the distances between the twisted pairs adjacent to each other do not vary, thus preventing the deterioration of the crosstalk characteristic of the LAN cable can be prevented.

Since the anchor filler includes the end portion circumscribed to the jacket at a curvature substantially equal to the inner curvature of the jacket, the twisted pairs can be prevented from moving in the direction parallel to the cross section.

Since the end portion includes the inscribed surface inscribed to the twisted pairs at a curvature substantially equal to the outer curvature of the twisted pairs, the twisted pairs can be prevented from moving in the direction parallel to the cross section.

Since the anchor filler includes the four spaces between the end portions for accommodating and arranging the twisted pairs, the anchor filler can accommodate and arrange the four twisted pairs.

And, since the twisted pairs are accommodated and arranged in the four sector-shaped spaces by the windmill filler, each of the twisted pairs can be held between the two partition walls and the jacket. Accordingly, the twisted pairs can be prevented from moving in the direction parallel to the cross section. Consequently, the twisted pairs can be prevented from moving in the horizontal direction with respect to the cutting plane, and the relative distances between the twisted pairs are constant, thus preventing the conventional deterioration of the crosstalk characteristic.

Since the windmill filler includes the four spaces between the end portions for accommodating and arranging the twisted pairs, the windmill filler can accommodate and arrange the four twisted pairs.

Sixth Embodiment

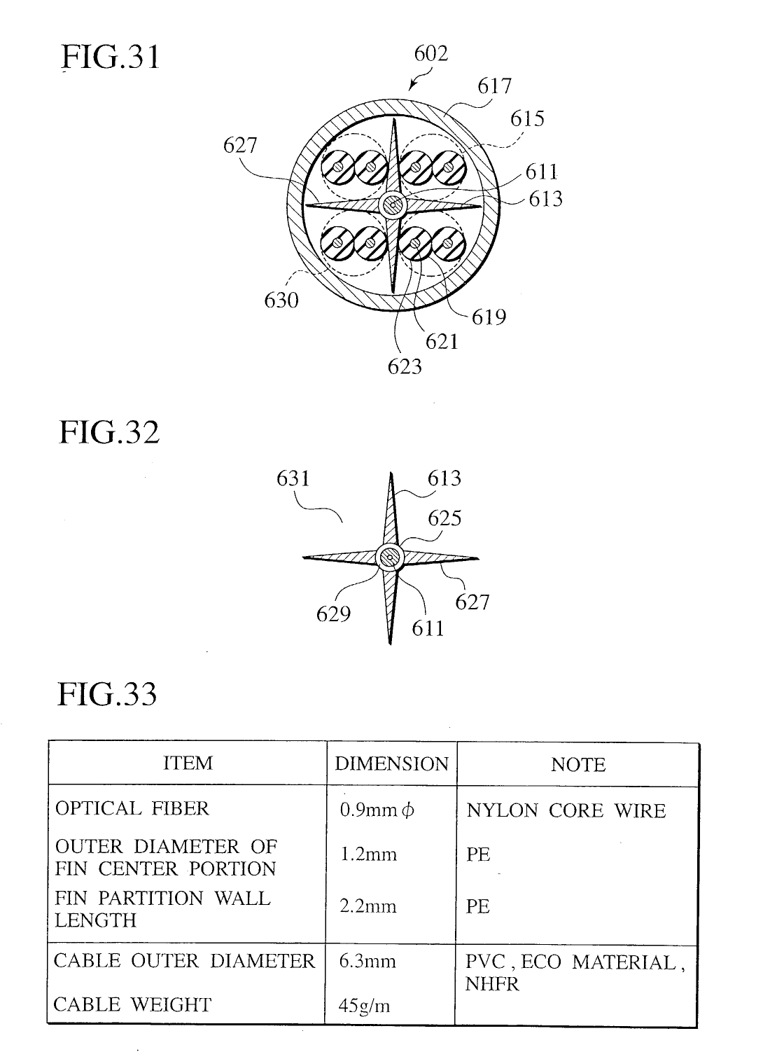

FIG. 31 is a cross-sectional view showing a constitution of a composite data transmission cable according to a sixth embodiment of the present invention. FIG. 32 is a cross-sectional view showing a constitution of a fin filler 613. In an optical fiber composite LAN cable 601, four twisted pairs 615 are collectively arranged around a fin filler 613 including four fin-shaped partition walls 627. An outer periphery thereof is covered with a jacket 617. Here, doted lines 630 of the twisted pairs 615 indicate trajectories when the twisted pairs 615 are twisted.

As shown in FIG. 32, the fin filler 613 includes four fin partition walls 627 radially extending from a filler center portion 625 in four directions. The twisted pairs 615 are arranged in respective separate spaces 631, each of which is formed between the two fin partition walls 627 radially extending from the filler center portion 625 so as to be orthogonal to each other.

Specifically, the fin filler 613 includes the fin center portion 625 having an optical fiber arranged in the center thereof and the fin partition walls 627 formed on the outer periphery of the fin center portion 625. The fin partition walls 627 extends outward from the fin center portion 625 while the partition walls 627 adjacent to each other form an angle of 90 degrees. Between the optical fiber 611 and the fin filler 613, a space 629 is provided. Even if the fin filler 613 is twisted, strain is not transferred to the optical fiber 611 itself. The fin filler 613 includes the four separate spaces 631 between the fin partition walls 627 adjacent to each other to accommodate and arrange the twisted pairs 615.

Referring to FIG. 31, each of the twisted pairs 615 is formed by twisting the two insulated wires 619. Each of the insulated wires 619 is formed by covering the center conductor 621 with the insulator 623 such as resin. The twisted pairs 615 are accommodated and arranged in the respective separate spaces 631 of the fin filler 613.

With reference to FIG. 33, a cable specification of the optical fiber composite LAN cable 601 will be described. The outer diameter of the optical fiber 611 is 0.9 mm. Preferably, the optical fiber 611 is a GI optical fiber or SM optical fiber. The outer diameter of the fin center portion 625 is, for example, 1.2 mm. Preferably, the material thereof is polyethylene (PE). The length of the fin partition walls 627 is, for example, 2.2 mm. Preferably, the material thereof is polyethylene (PE). In this case, the outer diameter of the optical fiber composite cable 601 is, for example, 6.3 mm. Preferably, the material of the jacket 617 is polyvinyl chloride (PVC), the recyclable eco material composed of the polyolefin material, or the NHFR material. The weight of the cable is, for example, 45 g/m. The eco material is similar to that in the first embodiment.

With reference to FIG. 31, an operational effect of the optical composite LAN cable 601 will be described. First, the four twisted pairs 615 are prepared, each of which is formed by twisting the two insulated wires 619, each formed by covering the center conductor 621 with the insulator 623. Subsequently, the optical fiber 611 is covered with polyethylene (PE). At this time, in order to form the space 629 between the optical fiber 611 and the fin filler 613, pipe extrusion is performed, or extrusion is performed with coating of powder, oil, a parting agent or the like. Four fin partition walls 627 are perpendicularly adhered to the fin center portion 625 thus formed. The twisted pairs 615 are then accommodated and arranged in the respective four separate spaces 631 formed by the fin partition walls 627. At last, the outer periphery thereof is covered with the jacket 617 to form the optical fiber composite LAN cable 601.

Since the fin center portion 625 including the optical fiber 611 in the center thereof is further provided with the fin partition walls 627 as described above, the twisted pairs 615 can be prevented from slipping down unlike the conventional twisted pairs 823. Furthermore, the distances between the twisted pairs adjacent to each other do not vary, and the disordered arrangement is prevented. Accordingly, the distances between the twisted pairs adjacent to each other can be maintained longer than the conventional one, thus preventing the deterioration of the crosstalk characteristic.

Since the optical fiber 611 and the fin filler 613 are not in close contact with each other, even if the fin filler 613 is twisted when the twisted pairs 615 are collected, it can be prevented that the distortion directly acts on the optical fiber 611. Accordingly, an increase in optical loss or rupture can be prevented.

And, since the optical fiber is integrated with the fin filler 613, even if installation of optical fibers is required along with an increase in the transmission speed and the transmission capacity in the future, it is unnecessary to lay a new optical cable.

Furthermore, since the distances between the twisted pairs 615 in the cross-sectional direction can be maintained longer than the conventional one, the twist pitch can be set longer. Accordingly, the manufacturing line speed in twisting can be increased, and the cable thus has an effect on reduction of the costs.

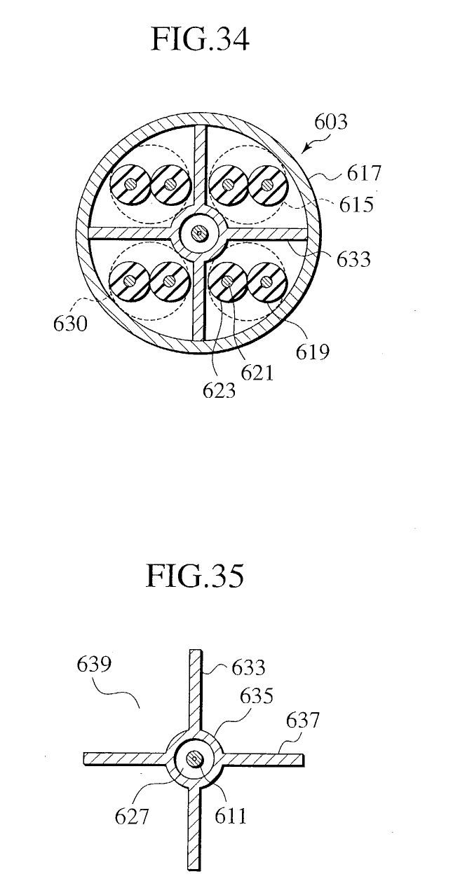

FIG. 34 is a cross-sectional view showing a constitution of a composite transmission cable according to a modification of the sixth embodiment of the present invention. FIG. 35 is a cross-sectional view showing a constitution of a cross-shaped filler 633. In an optical fiber composite LAN cable 603, the four twisted pairs 615 are collectively arranged around the cross-shaped filler 633 with a substantially cross-shaped cross section, and an outer periphery thereof is covered with the jacket 617.

As shown in FIG. 35, the cross-shaped filler 633 includes four rectangular partition walls 637 radially extending from a filler center portion 635 in four directions. The twisted pairs 615 are arranged in separate spaces 639, each of which is formed between the two partition walls 637 radially extending from the filler center portion 635 so as to be orthogonal to each other.

Specifically, the cross-shaped filler 633 includes the fin center portion 635 having the optical fiber 611 arranged in the center thereof and the partition walls 637 arranged on the outer periphery of the fin center portion 635. The partition walls 637 extend outward from the fin center portion 635 while the partition walls 637 adjacent to each other form an angle of 90 degrees. Between the optical fiber 611 and the cross-shaped filler 633, the space 627 is provided. Even if the cross-shaped filler 633 is twisted, strain is not transferred to the optical fiber 611 itself. The cross-shaped filler 633 includes the four separate spaces 639 between the partition walls 637 adjacent to each other to accommodate and arrange the twisted pairs 615.

Referring to FIG. 34, each of the twisted pairs 615 is formed by twisting the two insulated wires 619. Each of the insulated wires 619 is formed by covering the center conductor 621 with the insulator 623 such as resin. The twisted pairs 615 are arranged in the respective separate spaces 639 of the cross-shaped filler 633. A cable specification of the optical fiber composite LAN cable 603 is the same as that in FIG. 33, and the description thereof will be omitted.

With reference to FIG. 34, an operational effect of the optical fiber composite LAN cable 603 will be described. First, the four twisted pairs 615 are prepared, each of which is formed by twisting the two insulated wires 619, each formed by covering the center conductor 621 with the insulator 623. Subsequently, the twisted pairs 615 are arranged in the respective four separate spaces 639 of the cross-shaped filler 633. At last, the outer periphery thereof is covered with the jacket 617 to form the optical fiber composite LAN cable 603.

Consequently, since the twisted pairs 615 are arranged in the four separate spaces 639 by the cross-shaped filler 633, each of the twisted pairs 615 can be held between the two partition walls 637 and the jacket 617, thus preventing the twisted pairs 615 from moving in the direction parallel to the cross section. Consequently, the relative distances between the twisted pairs 615 are constant, thus preventing the conventional deterioration of the crosstalk characteristic.

Since the distances between the twisted pairs 615 in the cross-sectional direction can be maintained longer than the conventional one, the twist pitch can be set longer. Consequently, the manufacturing line speed in twisting can be increased, thus allowing reduction of the costs.

Furthermore, since the optical fiber 611 is previously provided in addition to the four twisted pairs 615, it becomes possible to smoothly shift to the optical fiber 611 in quick response to construction of an optical network in the future, thus reducing work for cable laying.

And, since the cross-shaped filler 633 includes the space 629 between the filler center portion 635 and the optical fiber 611, it is prevented that the strain due to the stress applied to the optical fiber composite LAN cable 603 when manufacturing or laying the cable directly acts on the optical fiber 611. Accordingly, an increase of the optical loss or rupture can be prevented.

According to the sixth aspect of the present invention, by using the cross-shaped filler including the optical fiber in the center thereof, the twisted pairs are arranged and maintained in the separate spaces constituted by the two partition walls. The twisted pairs can be prevented from moving in the direction parallel to the cross section. Consequently, the distances between the twisted pairs adjacent to each other do not vary, thus preventing the deterioration of the crosstalk characteristic of the optical fiber composite LAN cable.

Since the cross-shaped filler includes the space between the optical fiber and the center filler portion, even if the cross-shaped filler is twisted, strain is not transferred to the optical fiber itself inside thereof, and optical transmission performance is not lowered. And, it becomes possible to smoothly shift to the optical fiber in quick response to construction of an optical network in the future, thus reducing work for cable laying.

Furthermore, since the cross-shaped filler is provided with the four separate spaces for accommodating and arranging the twisted pairs between the partitions, the cross-shaped filler can accommodate and arrange the four twisted pairs.

This application claims benefit of priority under 35USC §119 to Japanese Patent Applications No. 2002-129911 filed on May 1, 2002, No. 2002-143689 filed on May 17, 2002, No. 2002-143693 filed on May 17, 2002, No. 2002-144904 filed on May 20, 2002, No. 2002-152271 filed on May 27, 2002, and No. 2002-154563 filed on May 28, 2002, the entire contents of which are incorporated by reference herein.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A data transmission cable, comprising:
a plurality of twisted pairs, each formed by twisting two insulated wires, and each of the insulated wires being formed by covering a conductor with an insulator;
a hollow filler composed of a tubular elastic body, the hollow filler being collectively arranged in contact with the plurality of twisted pairs; and
a jacket covering an outer periphery of the plurality of twisted pairs collectively arranged.

2. The data transmission cable according to claim 1, wherein
the hollow filler is composed of polyethylene and has an outer diameter of 0.9 to 1.2 mm and a thickness of 0.15 to 0.45 mm.

3. A data transmission cable, comprising:
a plurality of insulated wires, each formed by covering a conductor with an insulator;
a rhombus filler provided with a concave portion having a curvature substantially equal to a curvature of outer peripheries of the insulated wires;
a metallic tape shielding an outer periphery of the insulated wires, the insulated wires being arranged along the concave portion and twisted; and
a jacket member covering the metallic tape.

4. The data transmission cable according to claim 3, wherein
a curvature of the concave portion is larger than the curvature of the outer periphery of the insulated wires up to 1.5 times the curvature of the outer periphery thereof.

5. The data transmission cable according to claim 3, wherein
a cross section of the rhombus filler includes at least four concave portions,
a minimum distance between the concave portions facing each other is 0.414 times a diameter of the insulated wires, and
a distance between centers of the insulated wires facing each other is 1.414 times the diameter of the insulated wires.

6. A data transmission cable, comprising:
a plurality of twisted pairs, each formed by twisting two insulated wires, each of the insulated wires being formed by covering a conductor with an insulator;
a grooved filler having a round section provided with a plurality of concave grooves, each of which is in contact with part of a trajectory of each of the twisted pairs drawn in a twisting direction; and
an insulator covering an outer periphery of a combination integrated by collectively arranging the grooved filler and the twisted pairs.

7. The data transmission cable according to claim 6, wherein
an outer diameter of the grooved filler is substantially equal to a mean diameter of a center space formed by collectively arranging the twisted pairs.

8. The data transmission cable according to claim 6, wherein
the twisted pairs collectively arranged around the grooved filler and the grooved filler are integrally twisted.

9. The data transmission cable according to claim 6, further comprising
a metallic tape covering an inner surface of the insulator on an outer periphery of the combination integrated by collectively arranging the grooved filler and the twisted pairs.

10. A data transmission cable, comprising:
a plurality of twisted pairs, each formed by twisting two insulated wires, each of the insulated wires being formed by covering a conductor with an insulator;
a buffer layer lying for buffering in a portion where the plurality of twisted pairs are close to each other; and
a jacket covering an outer periphery of the plurality of twisted pairs.

11. The data transmission cable according to claim 10, wherein
the buffer layer further envelops each of the twisted pairs.

12. The data transmission cable according to claim 10, wherein
the buffer layer is composed of a cord-shaped PP yarn.

13. A data transmission cable, comprising:
a plurality of twisted pairs, each formed by twisting two insulated wires, each of the insulated wires being formed by covering a conductor with an insulator;
an anchor filler for accommodating and arranging the twisted wires in spaces of shape substantially equal to an outline of the twisted wires; and
a jacket member covering the anchor filler.

14. The data transmission cable according to claim 13, wherein
the anchor filler includes an end portion circumscribed to the jacket member at a curvature substantially equal to a curvature of an inner surface of the jacket member.

15. The data transmission cable according to claim 14, wherein
the end portion includes an inscribed surface inscribed to each of the twisted pairs at a curvature substantially equal to a curvature of an outer surface of the twisted pairs.

16. The data transmission cable according to claim 14, wherein
the anchor filler includes four spaces between the end portions adjacent to each other for accommodating and arranging the twisted pairs.

17. A data transmission cable, comprising:
a plurality of insulated wires, each formed by covering a conductor with an insulator;
a plurality of twisted pairs, each formed by twisting two of the insulated wires;
a windmill filler accommodating and arranging the twisted wires in sector-shaped spaces; and
a jacket covering an outer periphery of the windmill filler.

18. The data transmission cable according to claim 17, wherein
the windmill filler includes four spaces for accommodating and arranging the twisted pairs.

19. A data transmission cable, comprising:
a twisted pair formed by twisting insulated wires, each formed by covering a conductor with an insulator;
an cross-shaped filler including partition walls arranged to be orthogonal to each other in four directions from a center portion for accommodating and arranging the twisted pairs in separate spaces provided between the partition walls, an optical fiber being arranged in the center portion; and
a jacket member covering an outer periphery of the cross-shaped filler.

20. The data transmission cable according to claim 19, wherein
the cross-shaped filler includes a space between the cross-shaped filler and the optical fiber.

21. The data transmission cable according to claim 19, wherein
the cross-shaped filler is provided with four separate spaces between the partition walls for accommodating and arranging the twisted pairs.
